(19) United States
(12) Patent Application Publication
(10) Pub. No.: US 2026/0202931 A1
(43) Pub. Date: Jul. 16, 2026

(54) ELECTRONIC DEVICE

(71) Applicant: Samsung Display Co., Ltd., Yongin-si (KR)

(72) Inventors: HYUNGBAE KIM, Yongin-si (KR); SANGHYUN LIM, Yongin-si (KR)

(21) Appl. No.: 19/406,094

(22) Filed: Dec. 2, 2025

(30) Foreign Application Priority Data
Jan. 15, 2025 (KR) 10-2025-0006236

(51) Int. Cl. G06F 3/041; G06F 3/044

(52) U.S. Cl. CPC G06F 3/04166; G06F 3/0443; G06F 2203/04106; G06F 2203/04107; G06F 2203/04111

(57) ABSTRACT

An electronic device includes: a display layer; a sensor layer in which an active area and a peripheral area are defined and which includes a first electrode in the active area and extending in a first direction and a first trace line in the peripheral area and connected to the first electrode; a magnetic layer under the sensor layer; and a shielding layer spaced apart from the sensor layer with the magnetic layer interposed therebetween, wherein a first side surface of the magnetic layer and a second side surface of the shielding layer are between the first trace line and the first electrode.

### CROSS-REFERENCE TO RELATED APPLICATION

The present application claims priority to and the benefit of Korean Patent Application No. 10-2025-0006236, filed on Jan. 15, 2025, in the Korean Intellectual Property Office, the entire disclosure of which is incorporated herein by reference.

### BACKGROUND

Aspects of some embodiments of the present disclosure described herein relate to an electronic device having relatively improved pen sensing performance.

Multimedia electronic devices such as televisions, mobile phones, tablet computers, laptops, navigation systems, and game consoles include display panels for displaying images. In addition to a general input method such as a button, a keyboard, and a mouse, electronic devices may include a sensor layer (or an input sensor) capable of providing a touch-based input method that allows a user to input information or commands easily and intuitively. The sensor layer may sense a touch or pressure by the user. Meanwhile, consumer demand for the use of a pen for detailed touch input for users who are accustomed to inputting information using a writing instrument or a specific application (e.g., an application for sketching or drawing) is increasing.

The above information disclosed in this Background section is only for enhancement of understanding of the background and therefore the information discussed in this Background section does not necessarily constitute prior art.

### SUMMARY

Aspects of some embodiments of the present disclosure include an electronic device having relatively improved pen sensing performance.

According to some embodiments, an electronic device includes a display layer, a sensor layer in which an active area and a peripheral area are defined and which includes a first electrode in the active area and extending in a first direction and a first trace line in the peripheral area and connected to the first electrode, a magnetic layer under the sensor layer, and a shielding layer spaced apart from the sensor layer with the magnetic layer interposed therebetween, wherein a first side surface of the magnetic layer and a second side surface of the shielding layer are between the first trace line and the first electrode.

According to some embodiments, when viewed on a plane (e.g., in a plan view), an area of the sensor layer may be larger than an area of each of the magnetic layer and the shielding layer.

According to some embodiments, when viewed on a plane (e.g., in a plan view), the first trace line may not overlap the magnetic layer and the shielding layer.

According to some embodiments, when viewed on a plane (e.g., in a plan view), the first electrode may overlap the magnetic layer and the shielding layer.

According to some embodiments, the electronic device may further include a housing in which the display layer and the sensor layer are accommodated, wherein a first resistance of the shielding layer may be smaller than a second resistance of the housing.

According to some embodiments, the sensor layer may be on the display layer, and the sensor layer may further include a second electrode intersecting the first electrode and including a plurality of first patterns and a first bridge pattern electrically connected to the plurality of first patterns, a third electrode overlapping at least a portion of the first electrode and including a plurality of second patterns and a second bridge pattern electrically connected to the plurality of second patterns, and a fourth electrode intersecting the third electrode.

According to some embodiments, the first electrode and the plurality of first patterns may be on the same layer, and the plurality of second patterns and the fourth electrode may be on the same layer.

According to some embodiments, the electronic device may further include a cushion layer and an embossed layer between the display layer and the magnetic layer.

According to some embodiments, a third side surface of each of the cushion layer and the embossed layer may be aligned with the first side surface.

According to some embodiments, a third side surface of each of the cushion layer and the embossed layer may be aligned with a side surface of the sensor layer.

According to some embodiments, a first distance from a side surface of the sensor layer to the first side surface may be different from a second distance from the side surface of the sensor layer to the second side surface.

According to some embodiments, the sensor layer may be between the display layer and the magnetic layer, and the sensor layer may further include a crossing coil insulated from and cross the first electrode and the first trace line.

According to some embodiments, the first electrode and the first trace line may define a loop coil pattern.

According to some embodiments, an electronic device includes a display layer, a sensor layer which is on the display layer, in which an active area and a peripheral area are defined, and which includes a first electrode extending in a first direction and a first trace line connected to the first electrode, a magnetic layer under the sensor layer, a shielding layer spaced apart from the sensor layer with the magnetic layer interposed therebetween, and a housing in which the display layer, the sensor layer, the magnetic layer, and the shielding layer are accommodated, wherein, when viewed on a plane (e.g., in a plan view), an area of the sensor layer is larger than an area of each of the magnetic layer and the shielding layer.

According to some embodiments, a first side surface of the magnetic layer and a second side surface of the shielding layer may be between the first trace line and the first electrode.

According to some embodiments, when viewed on a plane (e.g., in a plan view), the first trace line may not overlap the magnetic layer and the shielding layer, and when viewed on a plane (e.g., in a plan view), the first electrode may overlap the magnetic layer and the shielding layer.

According to some embodiments, the sensor layer may further include a second electrode intersecting the first electrode and including a plurality of first patterns and a first bridge pattern electrically connected to the plurality of first patterns, a third electrode overlapping at least a portion of the first electrode and including a plurality of second patterns and a second bridge pattern electrically connected to the plurality of second patterns, and a fourth electrode intersecting the third electrode.

According to some embodiments, the electronic device may further include a cushion layer and an embossed layer between the display layer and the magnetic layer.

According to some embodiments, a third side surface of each of the cushion layer and the embossed layer may be aligned with the first side surface of the magnetic layer.

According to some embodiments, a third side surface of each of the cushion layer and the embossed layer may be aligned with a side surface of the sensor layer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects and features of embodiments according to the present disclosure will become more apparent by describing in more detail aspects of some embodiments thereof with reference to the accompanying drawings.

FIG. 1 is a block diagram of an electronic device according to some embodiments of the present disclosure.

FIG. 2 is a schematic view of the electronic device according to some embodiments.

FIG. 3 is a perspective view of the electronic device according to some embodiments of the present disclosure.

FIG. 4 is a schematic view for describing an operation of the electronic device according to some embodiments of the present disclosure.

FIG. 5 is a schematic cross-sectional view of the electronic device according to some embodiments of the present disclosure.

FIG. 6 is a cross-sectional view of a display module along line I-I′ of FIG. 3 according to some embodiments of the present disclosure.

FIG. 7 is a cross-sectional view illustrating some components of a sensor layer according to some embodiments of the present disclosure.

FIG. 8 is a plan view of the sensor layer according to some embodiments of the present disclosure.

FIG. 9A is a plan view illustrating a first conductive layer of a sensing unit according to some embodiments of the present disclosure.

FIG. 9B is an enlarged plan view of area XX′ illustrated in FIG. 9A according to some embodiments of the present disclosure.

FIG. 10A is a plan view illustrating a second conductive layer of the sensing unit according to some embodiments of the present disclosure.

FIG. 10B is an enlarged plan view of area YY′ illustrated in FIG. 10A according to some embodiments of the present disclosure.

FIG. 11 is a view illustrating an operation of a sensor driving unit according to some embodiments of the present disclosure.

FIG. 12 is a view illustrating the operation of the sensor driving unit according to some embodiments of the present disclosure.

FIG. 13 is a view for describing a first mode according to some embodiments of the present disclosure.

FIG. 14 is a view for describing a second mode according to some embodiments of the present disclosure.

FIG. 15A is a graph depicting a waveform of a first signal according to some embodiments of the present disclosure.

FIG. 15B is a graph depicting a waveform of a second signal according to some embodiments of the present disclosure.

FIG. 16 is a schematic cross-sectional view illustrating the electronic device and a pen according to some embodiments of the present disclosure.

FIG. 17A illustrates a magnetic flux density of a magnetic field according to some embodiments of the present disclosure.

FIG. 17B illustrates a vertical magnetic flux density of the magnetic field according to some embodiments of the present disclosure.

FIG. 18 is a plan view illustrating the sensor layer, a magnetic layer, and a shielding layer according to some embodiments of the present disclosure.

FIG. 19A is a view for describing the second mode according to some embodiments of the present disclosure.

FIG. 19B is a view for describing the second mode based on the one sensing unit according to some embodiments of the present disclosure.

FIG. 20 is a schematic cross-sectional view of the electronic device according to some embodiments of the present disclosure.

FIG. 21 is a schematic cross-sectional view of the electronic device according to some embodiments of the present disclosure.

FIG. 22 is a schematic cross-sectional view of the electronic device according to some embodiments of the present disclosure.

FIG. 23 is a view briefly illustrating some components of the electronic device according to some embodiments of the present disclosure.

FIG. 24 is a schematic cross-sectional view of the electronic device according to some embodiments of the present disclosure.

### DETAILED DESCRIPTION

In the specification, the expression that a first component (or area, layer, part, portion, etc.) is “located on”, “connected with” or “coupled to” a second component means that the first component is directly located on/connected with/coupled to the second component or means that a third component is interposed therebetween.

The same reference numerals refer to the same components. Further, in the drawings, the thickness, the ratio, and the dimension of components are exaggerated for effective description of technical contents. The expression “and/or” includes one or more combinations which associated components are capable of defining.

Although the terms “first”, “second”, etc. may be used to describe various components, the components should not be limited by the terms. The terms are used only to distinguish one component, one part, one area, one layer or one portion from another component, another part, another area, another layer or another portion. For example, without departing from the scope of the present disclosure, a first component, a first part, a first area, a first layer, or a first portion may be referred to as a second component, a second part, a second area, a second layer, or a second portion, and similarly, the second component, the second part, the second area, the second layer, or the second portion may also be referred to as the first component, the first part, the first area, the first layer, or the first portion. Singular expressions include plural expressions unless clearly otherwise indicated in the context.

Also, the terms “under”, “below”, “on”, “above”, etc. are used to describe the correlation of components illustrated in drawings. The terms that are relative in concept are described based on a direction illustrated in drawings.

It will be understood that the terms “include”, “comprise”, “have”, etc. specify the presence of features, numbers, steps, operations, elements, or components, described in the specification, or a combination thereof, and do not exclude in advance the presence or additional possibility of one or more other features, numbers, steps, operations, elements, or components or a combination thereof.

Unless otherwise defined, all terms (including technical terms and scientific terms) used in the specification have the same meaning as commonly understood by those skilled in the art to which the present disclosure belongs. Furthermore, terms such as terms defined in the dictionaries commonly used should be interpreted as having a meaning consistent with the meaning in the context of the related technology and should not be interpreted in overly ideal or overly formal meanings unless explicitly defined herein.

Hereinafter, aspects of some embodiments of the present disclosure will be described in more detail with reference to the accompanying drawings.

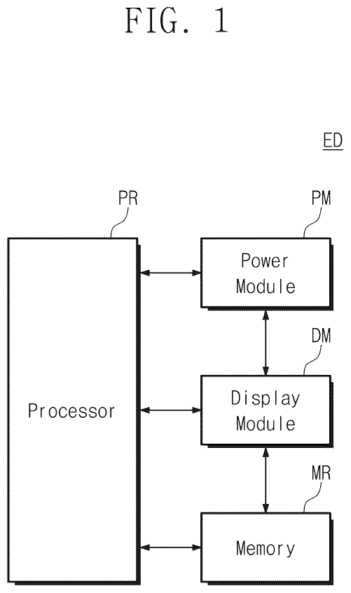

FIG. 1 is a block diagram of an electronic device according to some embodiments of the present disclosure.

The electronic device according to some embodiments of the present disclosure may be provided in various forms. The electronic device according to some embodiments of the present disclosure may further include a module or a device having another additional function.

Referring to FIG. 1, an electronic device ED according to some embodiments may include a display module DM, a processor PR, a memory MR, and a power module PM.

The processor PR may include at least one of a central processing unit (CPU), an application processor (AP), a graphic processing unit (GPU), a communication processor (CP), an image signal processor (ISP), or a controller. The processor PR may control the power module PM, the display module DM, and the memory MR.

Data information required for operating the processor PR or the display module DM may be stored in the memory MR. When the processor PR executes an application stored in the memory MR, an image data signal and/or an input control signal may be transmitted to the display module DM, and the display module DM may process the received signal and output image information through a display screen.

The power module PM may include a power supply module such as a power adapter or a battery device and a power conversion module that converts power supplied by the power supply module to generate power required for operating the electronic device ED.

The display module DM may be operated according to an electrical signal. Some of individual modules functionally included in one module may be included inside the display module DM, and the other thereof may be provided inside the electronic device ED separately from the display module DM.

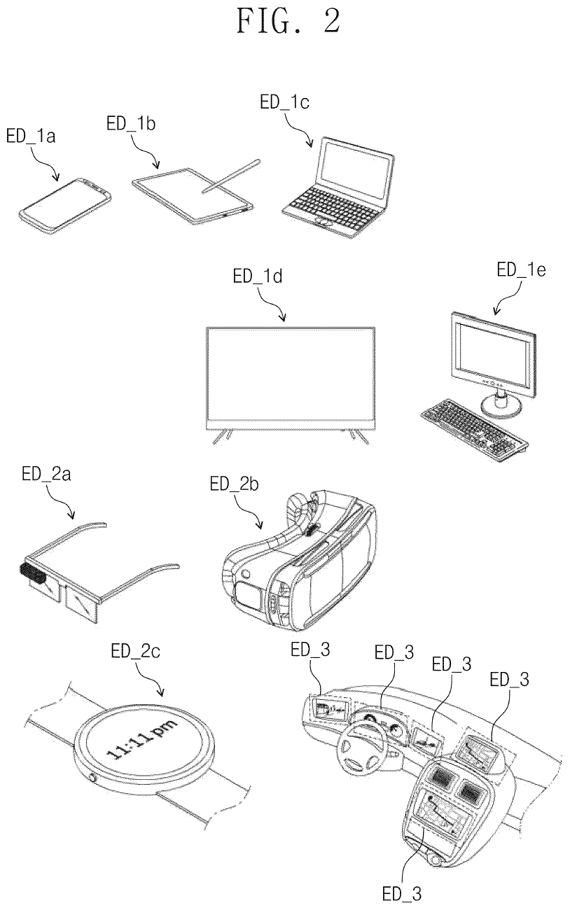

FIG. 2 is a schematic view of the electronic device according to some embodiments.

Referring to FIG. 2, the electronic device according to some embodiments may be not only image display electronic devices such as a smart phone ED_1a, a tablet PC ED_1b, a laptop computer ED_1c, a TV ED_1d, and a desk monitor ED_1e, but also wearable electronic devices including display modules such as smart glasses ED_2a, a head-mounted display ED_2b, and a smart watch ED_2c.

Further, the electronic device according to some embodiments may be applied to an interior of a transportation device such as a vehicle to provide various pieces of information to a user through an image. For example, the electronic device according to the present disclosure may be provided in the form of a vehicle electronic device ED-3 including a display module such as an instrument panel, a center fascia, a center information display (CID) located on a dashboard, and a room mirror display of the vehicle.

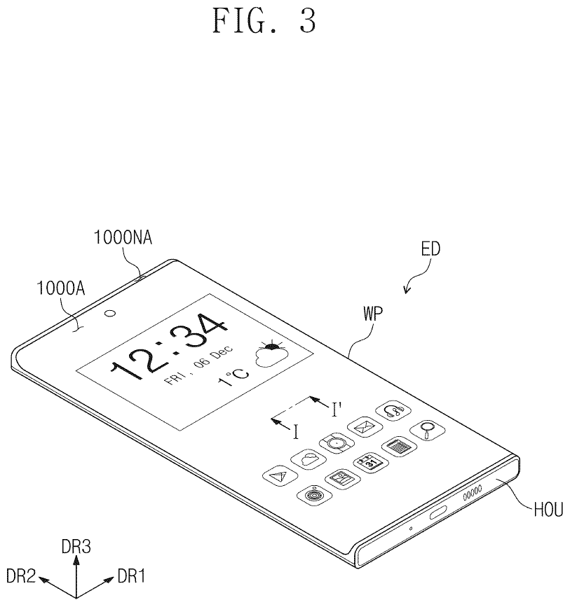

FIG. 3 is a perspective view of the electronic device according to some embodiments of the present disclosure.

Referring to FIG. 3, the electronic device ED may be a device that is activated according to an electric signal. For example, the electronic device ED may be a mobile phone, a foldable mobile phone, a laptop computer, a television, a tablet, a vehicle navigation system, a game console, or a wearable device, but embodiments according to the present disclosure are not limited thereto. FIG. 3 illustrates, by way of example, that the electronic device ED is a mobile phone.

The electronic device ED may include a window WP and a housing HOU. The processor PR (see FIG. 1), the power module PM (see FIG. 1), the display module DM (see FIG. 1), and the memory MR (see FIG. 1) may be accommodated in an internal space defined by the window WP and the housing HOU.

An active area 1000A and a peripheral area 1000NA may be defined in the electronic device ED. The electronic device ED may display an image through the active area 1000A. The active area 1000A may include a surface defined by a first direction DR1 and a second direction DR2. The peripheral area 1000NA may surround a periphery of the active area 1000A.

A thickness direction of the electronic device ED may be parallel to a third direction DR3 intersecting the first direction DR1 and the second direction DR2. Thus, front surfaces (or upper surfaces) and rear surfaces (or lower surfaces) of members constituting the electronic device ED may be defined based on the third direction DR3.

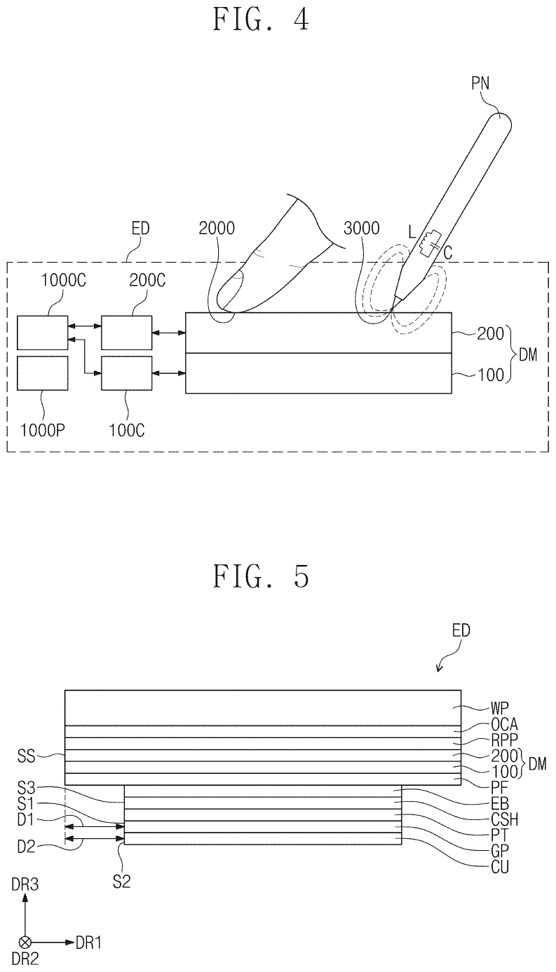

FIG. 4 is a schematic view for describing an operation of the electronic device according to some embodiments of the present disclosure.

Referring to FIG. 4, the electronic device ED may include the display module DM, a display driving unit 100C, a sensor driving unit 200C, a main driving unit 1000C, and a power circuit 1000P. The display module DM may include a display layer 100 and a sensor layer 200.

The display layer 100 may be a component that generates images. The display layer 100 may be a light emitting display layer. For example, the display layer 100 may be an organic light emitting display layer, an inorganic light emitting display layer, an organic-inorganic light emitting display layer, a quantum dot display layer, a micro-light emitting diode (LED) display layer, or a nano-LED display layer.

The sensor layer 200 may sense a first input 2000 or a second input 3000 applied from an external unit. The first input 2000 and the second input 3000 may be input means that may provide a change in a capacitance of the sensor layer 200 or may be input means that may cause an induced current in the sensor layer 200. For example, the first input 2000 may be a passive-type input means such as the human body of the user. The second input 3000 may be an input by a pen PN or an input by a radio frequency integrated circuit (RFIC) tag. For example, the pen PN may be a passive pen or an active pen.

According to some embodiments of the present disclosure, the pen PN may be a device that generates a magnetic field having a resonant frequency (e.g., a set or predetermined resonant frequency). The pen PN may be configured to transmit an output signal based on an electromagnetic resonance method. The pen PN may be referred to as an input device, an input pen, a magnetic pen, a stylus pen, or an electromagnetic resonance pen.

The pen PN may include an RLC resonant circuit, and the RLC resonant circuit may include an inductor “L” and a capacitor “C.” According to some embodiments of the present disclosure, the RLC resonant circuit may be a variable resonant circuit having a variable resonant frequency. In this case, the inductor “L” may be a variable inductor and/or the capacitor “C” may be a variable capacitor, but embodiments according to the present disclosure are not particularly limited thereto.

The inductor “L” generates a current by the magnetic field formed in the electronic device ED, for example, the sensor layer 200. However, embodiments according to the present disclosure are not particularly limited thereto. For example, when the pen PN operates as an active type, the pen PN may generate a current even when the pen PN does not receive a magnetic field from an external unit. The generated current is transmitted to the capacitor “C.” The capacitor “C” charges a current input from the inductor “L” and discharges the charged current to the inductor “L.” Thereafter, the inductor “L” may emit a magnetic field having a resonant frequency. The induced current may flow in the sensor layer 200 by the magnetic field emitted by the pen PN, and the induced current may be transmitted to the sensor driving unit 200C as a reception signal (or a sensing signal).

The main driving unit 1000C may control an overall operation of the electronic device ED. For example, the main driving unit 1000C may control operations of the display driving unit 100C and the sensor driving unit 200C. The main driving unit 1000C may include at least one microprocessor and may further include a graphic controller. The main driving unit 1000C may be referred to as an application processor, a central processing unit, or a main processor.

The display driving unit 100C may drive the display layer 100. The display driving unit 100C may receive image data and a control signal from the main driving unit 1000C. The control signal may include various signals. For example, the control signal may include an input vertical synchronization signal, an input horizontal synchronization signal, a main clock signal, a data enable signal, or the like.

The sensor driving unit 200C may drive the sensor layer 200. The sensor driving unit 200C may receive the control signal from the main driving unit 1000C. The control signal may include a clock signal of the sensor driving unit 200C. Further, the control signal may further include a mode determining signal that determines driving modes of the sensor driving unit 200C and the sensor layer 200.

The sensor driving unit 200C may be implemented as an integrated circuit IC and electrically connected to the sensor layer 200. For example, the sensor driving unit 200C may be directly mounted on an area (e.g., a set or predetermined area) of the display panel or mounted on a separate printed circuit board using a chip on film (COF) method and electrically connected to the sensor layer 200.

The sensor driving unit 200C and the sensor layer 200 may be selectively operated in a first mode or a second mode. For example, the first mode may be a mode for sensing a touch input, for example, the first input 2000. The second mode may be a mode for sensing the input by the pen PN, for example, the second input 3000. The first mode may be referred to as a touch sensing mode, and the second mode may be referred to as a pen sensing mode.

Switching between the first mode and the second mode may be performed in various manners. For example, the sensor driving unit 200C and the sensor layer 200 may be driven in the first mode and the second mode in a time division manner and may sense the first input 2000 and the second input 3000. Alternatively, the switching between the first mode and the second mode may be generated by selection by the user or by a specific action (or an input) of the user, any one of the first mode and the second mode may be activated or deactivated by activating or deactivating a specific application, or a current mode may be switched from one to the other one of the first mode and the second mode. Alternatively, while the sensor driving unit 200C and the sensor layer 200 are alternately operated in the first mode and the second mode, when the first input 2000 is sensed, the first mode is maintained or when the second input 3000 is sensed, the second mode is maintained.

The sensor driving unit 200C may calculate coordinate information of the input based on a signal received from the sensor layer 200 and provide a coordinate signal having the coordinate information to the main driving unit 1000C. The main driving unit 1000C executes an operation corresponding to the input of the user based on the coordinate signal. For example, the main driving unit 1000C may operate the display driving unit 100C so that a new application image is displayed on the display layer 100.

The power circuit 1000P may include a power management integrated circuit (PMIC). The power circuit 1000P may generate a plurality of driving voltages for driving the display layer 100, the sensor layer 200, the display driving unit 100C, and the sensor driving unit 200C. For example, the plurality of driving voltages may include a gate-high voltage, a gate-low voltage, a first driving voltage (e.g., an ELVSS voltage), a second driving voltage (e.g., an ELVDD voltage), an initialization voltage or the like, but embodiments according to the present disclosure are not particularly limited to the above example. The power circuit 1000P may be included in the power module PM (see FIG. 1).

FIG. 5 is a schematic cross-sectional view of the electronic device according to some embodiments of the present disclosure.

Referring to FIG. 5, the electronic device ED may include the window WP, an adhesive layer OCA, a reflection preventing layer RPP, the display module DM, a protective layer PF, an embossed layer EB, a cushion layer CSH, a reinforcing layer PT, a magnetic layer GP, and a shielding layer CU.

The window WP may constitute an exterior of the electronic device ED. The window WP may be a component that protects internal components of the electronic device ED from an external impact and provides an active area of the electronic device ED. For example, the window WP may include a glass substrate, a sapphire substrate, or a plastic film. The window WP may have a multi-layer or single-layer structure. For example, the window WP may have a laminated structure of a plurality of plastic films coupled with an adhesive or may have a laminated structure of a glass substrate and a plastic film coupled with an adhesive.

The adhesive layer OCA may be located under the window WP. The window WP and the reflection preventing layer RPP may be coupled to each other by the adhesive layer OCA. The adhesive layer OCA may include a general adhesive or a pressure sensitive adhesive. For example, the adhesive layer OCA may be an optically clear adhesive film, an optically clear resin, or a pressure sensitive adhesive film.

The reflection preventing layer RPP may be located under the window WP. The reflection preventing layer RPP may reduce a reflectance of a natural light (or sunlight) incident from an upper side of the window WP.

The sensor layer 200 may acquire coordinate information of an external input. The sensor layer 200 according to some embodiments of the present disclosure may be directly located on one surface of the display layer 100. For example, the sensor layer 200 may be formed integrally with the display layer 100 in an on-cell manner. The sensor layer 200 may be manufactured through a continuous process together with the display layer 100. However, embodiments according to the present disclosure are not limited thereto, and the sensor layer 200 may be manufactured by a separate process and adhere to the display layer 100. The sensor layer 200 may include a touch panel.

The display layer 100 may be located under the sensor layer 200. The display layer 100 may be a component that generates or displays images.

The protective layer PF may be located under the display layer 100. The protective layer PF may protect a lower surface of the display layer 100. The protective layer PF may include polyethylene terephthalate (PET). However, the material of the protective layer PF is not particularly limited thereto.

The embossed layer EB may be located under the protective layer PF. The embossed layer EB may be colored. For example, the embossed layer EB may be black. The embossed layer EB may absorb a light incident on the embossed layer EB. The embossed layer EB may be a layer having adhesive properties on both surfaces thereof. The embossed layer EB may include a general adhesive or a pressure sensitive adhesive. The protective layer PF and the cushion layer CSH may be coupled to each other by the embossed layer EB.

The cushion layer CSH may be located under the embossed layer EB. The cushion layer CSH may function to relieve a pressure applied from the outside. The cushion layer CSH may include a sponge, a foam, or an urethane resin. A thickness of the cushion layer CSH may be greater than a thickness of the embossed layer EB.

The reinforcing layer PT may be located under the cushion layer CSH. The reinforcing layer PT may include polyethylene terephthalate (PET). However, this is illustrative, and a material constituting the reinforcing layer PT according to some embodiments of the present disclosure is not limited thereto. For example, the reinforcing layer PT may include polyimide (PI). The reinforcing layer PT may support the embossed layer EB and the cushion layer CSH. However, this is illustrative, and the reinforcing layer PT according to some embodiments of the present disclosure may be omitted.

The magnetic layer GP may be located under the reinforcing layer PT. The magnetic layer GP may include a material having a relatively high magnetic permeability. For example, the magnetic layer GP may be a ferrite sheet. The magnetic layer GP may change a magnetic flux path of a magnetic field formed in the sensor layer 200 or a magnetic field provided from the outside of the electronic device ED. Accordingly, the magnetic layer GP may compensate for a magnetic flux density of the magnetic field.

The shielding layer CU may be located under the protective layer PF. The shielding layer CU may be conductive. For example, the shielding layer CU may include copper (Cu). For example, the shielding layer CU may be a copper tape. The shielding layer CU may shield the magnetic field using an eddy current generated inside the metal. The magnetic field may not be provided below the shielding layer CU due to the shielding layer CU.

A third side surface S3 of the cushion layer CSH and the embossed layer EB may be aligned with a first side surface S1 of the magnetic layer GP and a second side surface S2 of the shielding layer CU.

The first side surface S1 of the magnetic layer GP may be spaced a first distance D1 from a side surface SS of the sensor layer 200 toward a center of the sensor layer 200.

The second side surface S2 of the shielding layer CU may be spaced a second distance D2 from the side surface SS of the sensor layer 200 toward the center of the sensor layer 200.

The first distance D1 and the second distance D2 may be the same (or substantially the same).

A width of the display module DM in the first direction DR1 may be greater than a width of each of the magnetic layer GP and the shielding layer CU in the first direction DR1. When viewed on a plane (e.g., in a plan view), the display module DM may cover the magnetic layer GP and the shielding layer CU.

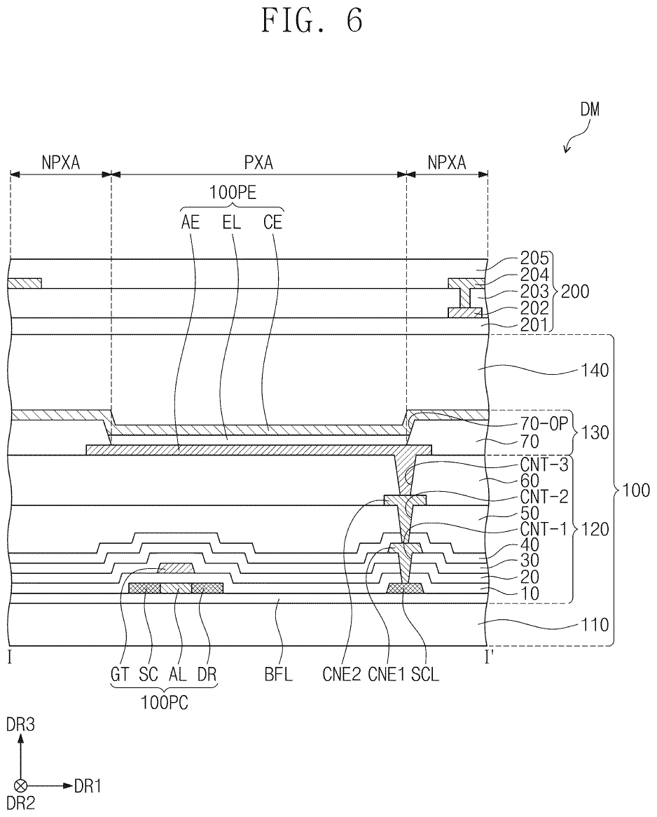

FIG. 6 is a cross-sectional view of a display module along line I-I′ of FIG. 3 according to some embodiments of the present disclosure.

Referring to FIG. 6, at least one buffer layer BFL is formed on an upper surface of a base layer 110. The buffer layer BFL may improve a coupling force between the base layer 110 and a semiconductor pattern. The buffer layer BFL may be formed in multiple layers. Alternatively, the display layer 100 may further include a barrier layer. The buffer layer BFL may include at least one of a silicon oxide, a silicon nitride, or a silicon oxy nitride. For example, the buffer layer BFL may include a structure in which silicon oxide layers and silicon nitride layers are alternately laminated.

Semiconductor patterns SC, AL, DR, and SCL may be arranged on the buffer layer BFL. The semiconductor patterns SC, AL, DR, and SCL may include polysilicon. However, embodiments according to the present disclosure are not limited thereto, and the semiconductor patterns SC, AL, DR, and SCL may also include an amorphous silicon, a low-temperature polycrystalline silicon, or an oxide semiconductor.

FIG. 6 merely illustrates some of the semiconductor patterns SC, AL, DR, and SCL, and the semiconductor pattern may be further arranged in other areas. The semiconductor patterns SC, AL, DR, and SCL may be arranged in a specific rule across pixels. The semiconductor patterns SC, AL, DR, and SCL may have different electrical properties depending on whether or not the semiconductor patterns SC, AL, DR, and SCL are doped. The semiconductor patterns SC, AL, DR, and SCL may include the first areas SC, DR, and SCL having high conductivity and the second area AL having low conductivity. The first areas SC, DR, and SCL may be doped with an N-type dopant or a P-type dopant. A P-type transistor may include a doped area doped with the P-type dopant, and an N-type transistor may include a doped area doped with the N-type dopant. The second area AL may be a non-doped area or an area doped at a lower concentration than the first areas SC, DR, and SCL.

A conductivity of the first areas SC, DR, and SCL may be greater than a conductivity of the second area AL, and the first areas SC, DR, and SCL may serve as an electrode or a signal line. The second area AL may correspond to the active area AL (or a channel) of a transistor 100PC. In other words, the part AL of the semiconductor patterns SC, AL, DR, and SCL may be the active area AL of the transistor 100PC, other parts SC and DR may be the source area SC or the drain area DR of the transistor 100PC, and the other part SCL may be a connection electrode or a connection signal line SCL.

Each of pixels may have an equivalent circuit including a plurality of transistors, at least one capacitor, and at least one light emitting element, and the equivalent circuit of the pixel may be modified into various forms. FIG. 6 illustratively illustrates the one transistor 100PC and one light emitting element 100PE included in the pixel.

The source area SC, the active area AL, and the drain area DR of the transistor 100PC may be formed from the semiconductor patterns SC, AL, DR, and SCL. The source area SC and the drain area DR may extend from the active area AL in opposite directions on a cross section. FIG. 6 illustrates a portion of the connection signal line SCL formed from the semiconductor patterns SC, AL, DR, and SCL. Although not separately illustrated, the connection signal line SCL may be connected to the drain area DR of the transistor 100PC on a plane.

A first insulating layer 10 may be located on the buffer layer BFL. The first insulating layer 10 may commonly overlap the plurality of pixels and cover the semiconductor patterns SC, AL, DR, and SCL. The first insulating layer 10 may be an inorganic layer and/or an organic layer and may have a single-layer structure or a multi-layer structure. The first insulating layer 10 may include at least one of an aluminum oxide, a titanium oxide, a silicon oxide, a silicon nitride, a silicon oxy nitride, a zirconium oxide, or a hafnium oxide. According to some embodiments, the first insulating layer 10 may be a single-layer silicon oxide layer. The first insulating layer 10 and an insulating layer of a circuit layer 120, which will be described below, may be an inorganic layer and/or an organic layer and may have a single-layer structure or a multi-layer structure. The inorganic layer may include at least one of the above-described materials, but embodiments according to the present disclosure are not limited thereto.

A gate GT of the transistor 100PC is located on the first insulating layer 10. The gate GT may be a portion of a metal pattern. The gate GT overlaps the active area AL. In a process of doping or reducing the semiconductor patterns SC, AL, DR, and SCL, the gate GT may function as a mask.

A second insulating layer 20 may be located on the first insulating layer 10 and cover the gate GT. The second insulating layer 20 may commonly overlap the pixels. The second insulating layer 20 may be an inorganic layer and/or an organic layer and may have a single-layer structure or a multi-layer structure. The second insulating layer 20 may include at least one of a silicon oxide, a silicon nitride, or a silicon oxy nitride. According to some embodiments, the second insulating layer 20 may have a multi-layer structure including a silicon oxide layer and a silicon nitride layer.

A third insulating layer 30 may be located on the second insulating layer 20. The third insulating layer 30 may have a single-layer structure or a multi-layer structure. For example, the third insulating layer 30 may have a multi-layer structure including a silicon oxide layer and a silicon nitride layer.

A first connection electrode CNE1 may be located on the third insulating layer 30. The first connection electrode CNE1 may be connected to the connection signal line SCL through a contact hole CNT-1 passing through the first insulating layer 10, the second insulating layer 20, and the third insulating layer 30.

A fourth insulating layer 40 may be located on the third insulating layer 30. The fourth insulating layer 40 may be a single-layer silicon oxide layer. A fifth insulating layer 50 may be located on the fourth insulating layer 40. The fifth insulating layer 50 may be an organic layer.

A second connection electrode CNE2 may be located on the fifth insulating layer 50. The second connection electrode CNE2 may be connected to the first connection electrode CNE1 through a contact hole CNT-2 passing through the fourth insulating layer 40 and the fifth insulating layer 50.

A sixth insulating layer 60 may be located on the fifth insulating layer 50 to cover the second connection electrode CNE2. The sixth insulating layer 60 may be an organic layer.

A light emitting element layer 130 may be located on the circuit layer 120. The light emitting element layer 130 may include the light emitting element 100PE. For example, the light emitting element layer 130 may include an organic light emitting material, an inorganic light emitting material, an organic-inorganic light emitting material, a quantum dot, a quantum rod, a micro-LED, or a nano-LED. Hereinafter, it will be described that the light emitting element 100PE is an organic light emitting element, but embodiments according to the present disclosure are not particularly limited thereto.

The light emitting element 100PE may include a first electrode AE, a light emitting layer EL, and a second electrode CE.

The first electrode AE may be located on the sixth insulating layer 60. The first electrode AE may be connected to the second connection electrode CNE2 through a contact hole CNT-3 passing through the sixth insulating layer 60.

A pixel defining film 70 may be located on the sixth insulating layer 60 and cover a portion of the first electrode AE. An opening 70-OP is defined in the pixel defining film 70. The opening 70-OP of the pixel defining film 70 exposes at least a portion of the first electrode AE.

The active area 1000A (see FIG. 3) may include a light emitting area PXA and a non-light emitting area NPXA adjacent to the light emitting area PXA. The non-light emitting area NPXA may surround the light emitting area PXA. According to some embodiments, the light emitting area PXA is defined to correspond to a partial area of the first electrode AE, which is exposed by the opening 70-OP.

The light emitting layer EL may be located on the first electrode AE. The light emitting layer EL may be located in an area corresponding to the opening 70-OP. FIG. 6 illustratively illustrates that the light emitting layer EL is located inside the opening 70-OP, but embodiments according to the present disclosure are not limited thereto. For example, the light emitting layer EL may extend to cover portions of a side surface of the pixel defining film 70 and an upper surface of the pixel defining film 70, which define the opening 70-OP.

According to some embodiments of the present disclosure, the light emitting layer EL may be formed separately from each of the pixels. When the light emitting layer EL is formed separately from each of the pixels, each of the light emitting layers EL may emit a light having at least one of a blue color, a red color, or a green color. However, embodiments according to the present disclosure are not limited thereto, and the light emitting layer EL may have an integral shape and may be commonly included in the plurality of pixels. In this case, the light emitting layer EL may also provide a blue light or a white light.

The second electrode CE may be located on the light emitting layer EL. The second electrode CE may have an integral shape and may be commonly included in the plurality of pixels.

According to some embodiments of the present disclosure, a hole control layer may be located between the first electrode AE and the light emitting layer EL. The hole control layer may be commonly located in the light emitting area PXA and the non-light emitting area NPXA. The hole control layer may include a hole transport layer and may further include a hole injection layer. An electron control layer may be located between the light emitting layer EL and the second electrode CE. The electron control layer may include an electron transport layer and may further include an electron injection layer. The hole control layer and the electron control layer may be commonly formed in the plurality of pixels by using an open mask or an inkjet process.

An encapsulation layer 140 may be located on the light emitting element layer 130. The encapsulation layer 140 may include an inorganic layer, an organic layer, and an inorganic layer that are sequentially laminated, but layers constituting the encapsulation layer 140 are not limited thereto. The inorganic layers may protect the light emitting element layer 130 from moisture and oxygen, and the organic layer may protect the light emitting element layer 130 from foreign substances or contaminants such as dust particles. The inorganic layers may include a silicon nitride layer, a silicon oxy nitride layer, a silicon oxide layer, a titanium oxide layer, an aluminum oxide layer or the like. The organic layer may include an acryl-based organic layer, and embodiments according to the present disclosure are not limited thereto.

The sensor layer 200 may include a base layer 201, a first conductive layer 202, an intermediate insulating layer 203, a second conductive layer 204, and a cover insulating layer 205.

The base layer 201 may be an inorganic layer including at least one of a silicon nitride, a silicon oxy nitride, or a silicon oxide. Alternatively, the base layer 201 may be an organic layer including an epoxy resin, an acryl-based resin, or an imide-based resin. The base layer 201 may have a single-layer structure or have a multi-layer structure in which layers are laminated in the third direction DR3. According to some embodiments of the present disclosure, the sensor layer 200 may not include the base layer 201.

Each of the first conductive layer 202 and the second conductive layer 204 may have a single-layer structure or have a multi-layer structure in which layers are laminated in the third direction DR3.

Each of the first conductive layer 202 and the second conductive layer 204 having a single-layer structure may include a metal layer or a transparent conductive layer. The metal layer may include molybdenum, silver, titanium, copper, aluminum, or alloys thereof. The transparent conductive layer may include a transparent conductive oxide such as an indium tin oxide (ITO), an indium zinc oxide (IZO), a zinc oxide (ZnO), or an indium zinc tin oxide (IZTO). In addition, the transparent conductive layer may include a conductive polymer such as poly(3,4-ethylenedioxythiophene) (PEDOT), a metal nanowire, graphene, or the like.

Each of the first conductive layer 202 and the second conductive layer 204 having a multi-layer structure may include metal layers. The metal layers may have, for example, a three-layer structure of titanium/aluminum/titanium. The conductive layer having a multi-layer structure may include at least one metal layer and at least one transparent conductive layer.

According to some embodiments of the present disclosure, a thickness of the first conductive layer 202 may be greater than or equal to a thickness of the second conductive layer 204. When the thickness of the first conductive layer 202 is greater than the thickness of the second conductive layer 204, a resistance of a component (e.g., an electrode, a pattern, a bridge pattern, or the like) included in the first conductive layer 202 may be decreased. Further, because the first conductive layer 202 is located under the second conductive layer 204, even when the thickness of the first conductive layer 202 is increased, a probability that components included in the first conductive layer 202 are visually recognized due to reflection of an external light may be smaller than that of the second conductive layer 204.

At least one of the intermediate insulating layer 203 or the cover insulating layer 205 may include an inorganic film. The inorganic film may include at least one of an aluminum oxide, a titanium oxide, a silicon oxide, a silicon nitride, a silicon oxy nitride, a zirconium oxide, or a hafnium oxide.

At least one of the intermediate insulating layer 203 or the cover insulating layer 205 may include an organic film. The organic film may include at least one of an acryl-based resin, a methacrylate-based resin, a polyisoprene-based resin, a vinyl-based resin, an epoxy-based resin, a urethane-based resin, a cellulose-based resin, a siloxane-based resin, a polyimide-based resin, a polyamide-based resin, or a perylene-based resin.

The fact that the sensor layer 200 includes the first conductive layer 202 and the second conductive layer 204, that is, a total of two conductive layers, has been described above, but embodiments according to the present disclosure are not particularly limited thereto. For example, the sensor layer 200 may include three or more conductive layers.

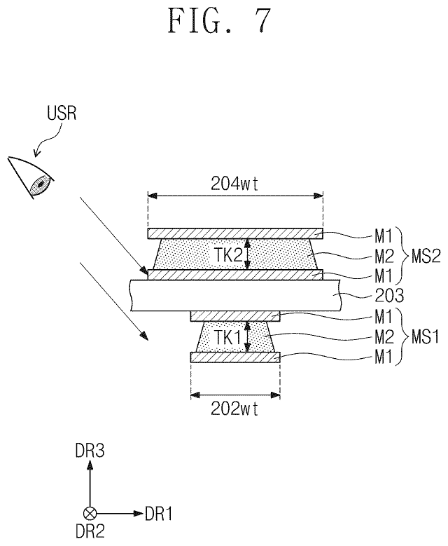

FIG. 7 is a cross-sectional view illustrating some components of a sensor layer according to some embodiments of the present disclosure.

Referring to FIGS. 6 and 7, a second width 204wt of a second mesh line MS2 included in the second conductive layer 204 may be greater than or equal to a first width 202wt of a first mesh line MS1 included in the first conductive layer 202. When a user USR views the first mesh line MS1 and the second mesh line MS2 from a side surface, the first mesh line MS1 has a width that is smaller than that of the second mesh line MS2, and thus a probability that the first mesh line MS1 is visually recognized by the user USR may be decreased.

Each of the first mesh line MS1 and the second mesh line MS2 may include first metal layers M1 and a second metal layer M2 located between the first metal layers M1. Illustratively, the first metal layers M1 may include titanium (Ti), and the second metal layer M2 may include aluminum (Al). However, this is merely an example, and embodiments according to the present disclosure are not particularly limited thereto.

According to some embodiments of the present disclosure, a first thickness TK1 of the second metal layer M2 of the first mesh line MS1 may be the same (or substantially the same) as a second thickness TK2 of the second metal layer M2 of the second mesh line MS2, but embodiments according to the present disclosure are not particularly limited thereto. For example, the first thickness TK1 may be greater than the second thickness TK2. Alternatively, the second thickness TK2 may be greater than the first thickness TK1. According to some embodiments of the present disclosure, each of the first thickness TK1 and the second thickness TK2 may be 1,000 Å or more, for example, 6,000 Å.

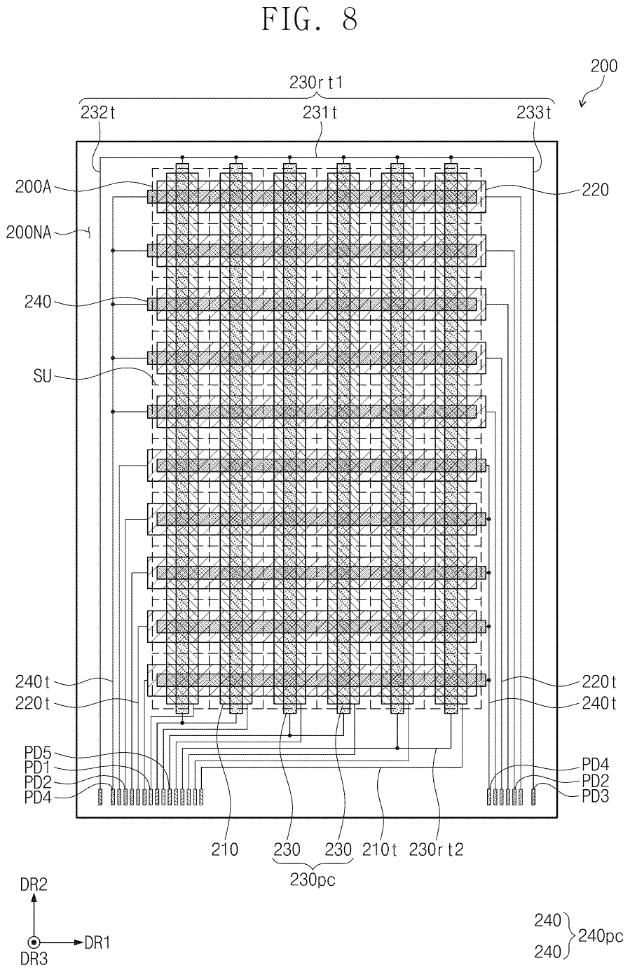

FIG. 8 is a plan view of the sensor layer according to some embodiments of the present disclosure.

Referring to FIG. 8, an active area 200A and a peripheral area 200NA adjacent to the active area 200A may be defined in the sensor layer 200.

The sensor layer 200 may include a plurality of first electrodes 210, a plurality of second electrodes 220, a plurality of third electrodes 230, and a plurality of fourth electrodes 240, which are arranged in the active area 200A.

The first electrodes 210 may intersect the second electrodes 220. Each of the first electrodes 210 may extend in the second direction DR2, and the first electrodes 210 may be arranged to be spaced apart from each other in the first direction DR1. Each of the second electrodes 220 may extend in the first direction DR1, and the second electrodes 220 may be arranged to be spaced apart from each other in the second direction DR2. A sensing unit SU of the sensor layer 200 may be an area in which the one first electrode 210 and the one second electrode 220 intersect each other.

FIG. 8 illustratively illustrates six first electrodes 210 and ten second electrodes 220 and illustratively illustrates 60 sensing units SU, but the number of first electrodes 210 and the number of second electrodes 220 are not limited thereto.

The shape of the sensing unit SU illustrated in FIG. 8 is merely an example, and embodiments according to the present disclosure are not limited thereto. The shape of the sensing unit SU may be variously modified.

Each of the third electrodes 230 may extend in the second direction DR2, and the third electrodes 230 may be arranged to be spaced apart from each other in the first direction DR1. The one third electrode 230 may at least partially overlap the one first electrode 210. According to some embodiments of the present disclosure, an overlapping area between the one first electrode 210 and the one third electrode 230 may be adjusted to adjust a capacitance (or a coupling capacitance) between the one first electrode 210 and the one third electrode 230.

According to some embodiments of the present disclosure, at least some of the third electrodes 230 may be connected in parallel to each other. For example, FIG. 8 illustratively illustrates that the two third electrodes 230 are connected in parallel to each other to constitute a first electrode group 230pc, and the three first electrode groups 230pc may be arranged in the first direction DR1. However, the number of third electrodes 230 constituting the first electrode group 230pc is not limited thereto. For example, the one first electrode group 230pc may include only the one third electrode 230 or may include three or more third electrodes 230.

As the number of third electrodes 230 included in the first electrode group 230pc and connected in parallel to each other is increased, a resistance of the first electrode group 230pc is decreased, and thus power efficiency may be relatively improved, and sensing sensitivity may be relatively improved. In contrast, as the number of third electrodes 230 included in the first electrode group 230pc is decreased, a loop coil pattern formed using the first electrode group 230pc may be implemented in more various forms.

The fourth electrodes 240 may be arranged in the second direction DR2, and the fourth electrodes 240 may extend in the first direction DR1. The one fourth electrode 240 may at least partially overlap the one second electrode 220. According to some embodiments of the present disclosure, an overlapping area between the one second electrode 220 and the one fourth electrode 240 may be adjusted to adjust a capacitance (or a coupling capacitance) between the one second electrode 220 and the one fourth electrode 240.

According to some embodiments of the present disclosure, at least some of the fourth electrodes 240 may be electrically connected to each other to constitute one second electrode group 240pc. For example, FIG. 8 illustratively illustrates that the five fourth electrodes 240 are connected to the same one trace line, for example, a fourth trace line 240t, to constitute the one second electrode group 240pc. Thus, FIG. 8 illustrates that the two second electrode groups 240pc are arranged in the second direction DR2. However, the number of fourth electrodes 240 constituting the one second electrode group 240pc is not limited thereto. For example, the number of fourth electrodes 240 constituting the one second electrode group 240pc may be ten, and in this case, the sensor layer 200 may include only the one second electrode group 240pc.

The sensor layer 200 may further include a plurality of first trace lines 220t arranged in the peripheral area 200NA, a plurality of first pads PD1 connected to the first trace lines 210t in one-to-one correspondence, a plurality of second trace lines 220t, and a plurality of second pads PD2 connected to the second trace lines 220t in one-to-one correspondence. The first trace lines 210t may be electrically connected to the first electrodes 210 in one-to-one correspondence. The second trace lines 220t may be electrically connected to the second electrodes 220 in one-to-one correspondence.

The sensor layer 200 may further include a third trace line 230rt1 located in the peripheral area 200NA, a plurality of third pads PD3 connected to one end and the other end of the third trace line 230rt1, fourth trace lines 240t, fourth pads PD4 connected to the fourth trace lines 240t in one-to-one correspondence, fifth trace lines 230rt2, and fifth pads PD5 connected to the fifth trace lines 230rt2 in one-to-one correspondence.

The third trace line 230rt1 may be electrically connected to the third electrodes 230. According to some embodiments of the present disclosure, the third trace line 230rt1 may be electrically connected to all the third electrodes 230. The third trace line 230rt1 may include a first line part 231t extending in the first direction DR1 and electrically connected to the third electrodes 230, a second line part 232textending from a first end of the first line part 231t in the second direction DR2, and a third line part 233t extending from a second end of the first line part 231t in the second direction DR2.

According to some embodiments of the present disclosure, each of a resistance of the second line part 232t and a resistance of the third line part 233t may be the same (or substantially the same) as a resistance of one of the third electrodes 230. Thus, the second line part 232t and the third line part 233t may serve as the third electrodes 230, and the same effect may be obtained as if the third electrodes 230 are also arranged in the peripheral area 200NA. For example, any one of the second line part 232t and the third line part 233t and any one of the third electrodes 230 may form a coil. Thus, the pen positioned in an area adjacent to the peripheral area 200NA may also be sufficiently charged by a loop including the second line part 232t or the third line part 233t.

According to some embodiments of the present disclosure, a width of each of the second line part 232t and the third line part 233t in the first direction DR1 may be adjusted to adjust the resistance of the second line part 232t and the resistance of the third line part 233t. However, this is merely an example, and the first line part 231t, the second line part 232t, and the third line part 233t may have the same (or substantially the same) width.

The fifth trace lines 230rt2 may be connected to the first electrode groups 230pc in one-to-one correspondence. That is, the number of fifth trace lines 230rt2 may correspond to the number of first electrode groups 230pc. FIG. 7 illustratively illustrates the three fifth trace lines 230rt2 and the three first electrode groups 230pc.

According to some embodiments of the present disclosure, the fifth trace lines 230rt2 and the fifth pads PD5 may be omitted.

The fourth trace lines 240t may be spaced apart from each other with the active area 200A interposed therebetween. The fourth trace lines 240t may be electrically connected to the second electrode groups 240pc in one-to-one correspondence. FIG. 7 illustratively illustrates that the two second electrode groups 240pc are arranged. The fourth trace line 240t connected to the one second electrode group 240pc and the fourth trace line 240t connected to the other one second electrode group 240pc may be spaced apart from each other with the active area 200A interposed therebetween. However, embodiments according to the present disclosure are not particularly limited thereto.

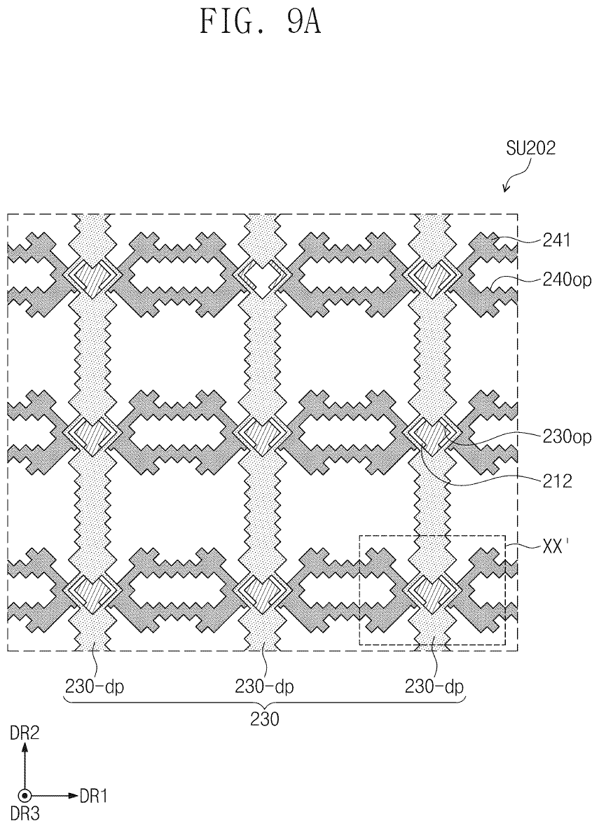

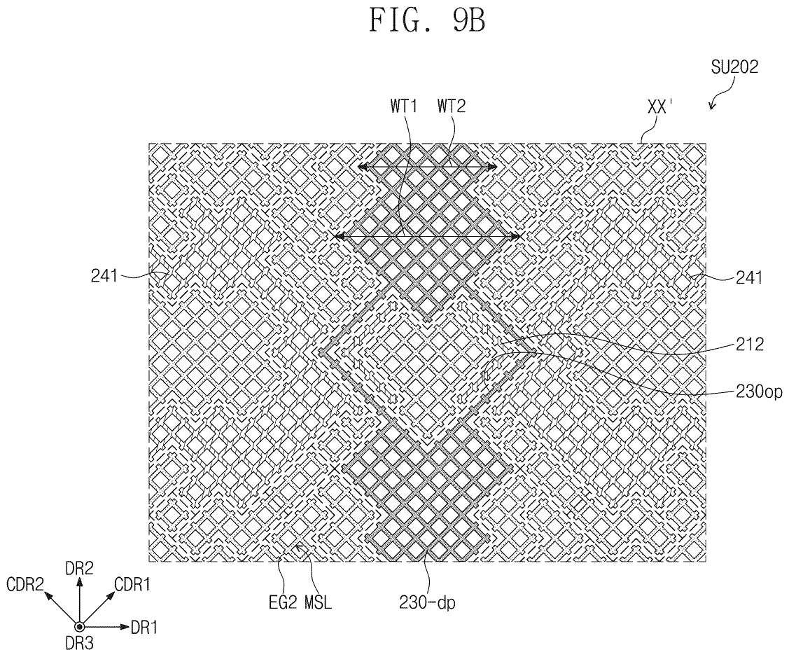

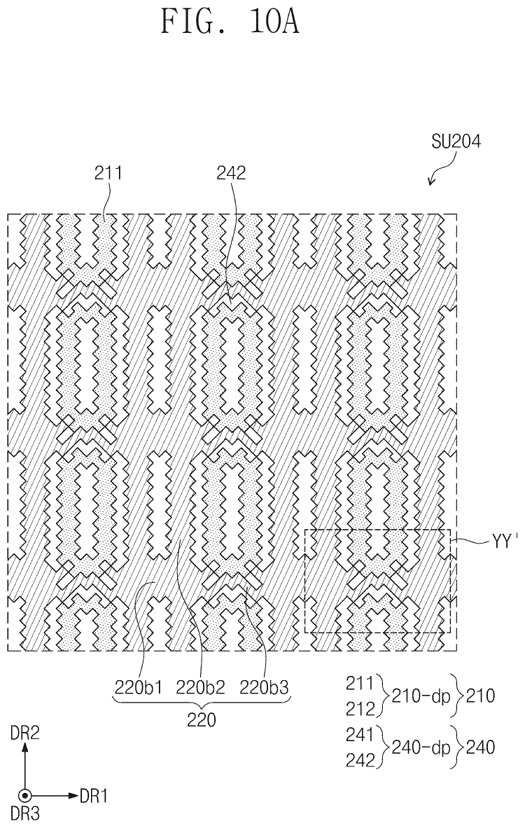

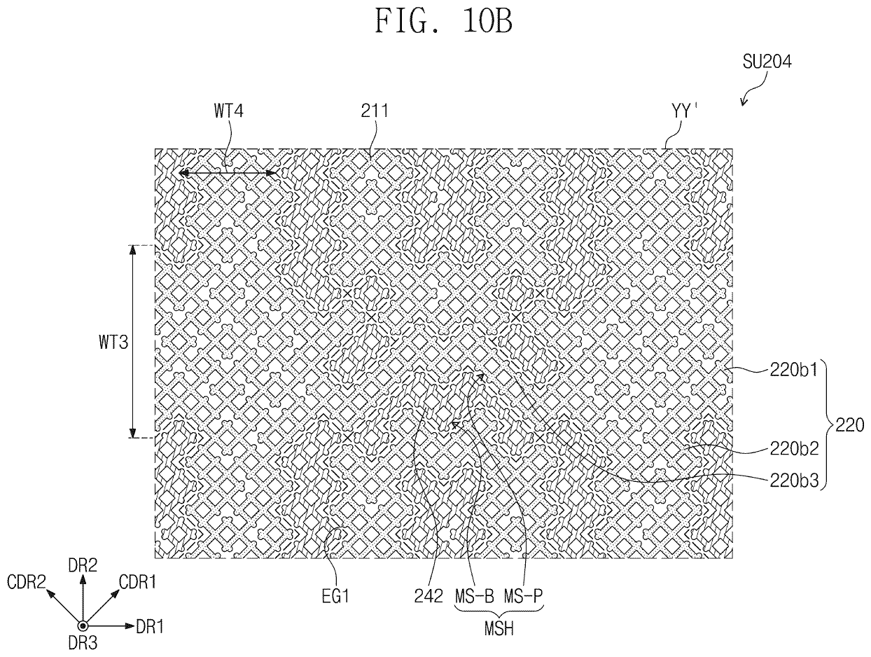

FIG. 9A is a plan view illustrating a first conductive layer of a sensing unit according to some embodiments of the present disclosure, FIG. 9B is an enlarged plan view of area XX′ illustrated in FIG. 9A according to some embodiments of the present disclosure, FIG. 10A is a plan view illustrating a second conductive layer of the sensing unit according to some embodiments of the present disclosure, and FIG. 10B is an enlarged plan view of area YY′ illustrated in FIG. 10A according to some embodiments of the present disclosure.

Referring to FIGS. 8 to 10B, the first electrode 210 may include a plurality of first segmented electrodes 210-dp spaced apart from each other in the first direction DR1. Each of the first segmented electrodes 210-dp may include a plurality of first patterns 211 and a plurality of first bridge patterns 212 electrically connected to the first patterns 211. The first patterns 211 spaced apart from each other in the second direction DR2 may be electrically connected by the first bridge patterns 212. Thus, each of the first segmented electrodes 210-dp may extend in the second direction DR2, and the first segmented electrodes 210-dp may be spaced apart from each other in the first direction DR1.

The third electrode 230 may include a plurality of second segmented electrodes 230-dp spaced apart from each other in the first direction DR1. Each of the second segmented electrodes 230-dp may extend in the second direction DR2. The second segmented electrodes 230-dp may be spaced apart from each other in the first direction DR1.

When viewed in the third direction DR3 (e.g., in a plan view), the second segmented electrodes 230-dp may overlap the first segmented electrodes 210-dp in one-to-one correspondence. The wording “overlapping” also includes meaning that at least a portion of the one first segmented electrode 210-dp and at least a portion of the one second segmented electrode 230-dp overlap each other.

FIGS. 9A and 10A illustratively illustrate that the one sensing unit SU includes the three first segmented electrodes 210-dp and the three second segmented electrodes 230-dp, but embodiments according to the present disclosure are not particularly limited thereto. For example, the number of first segmented electrodes 210-dp and the number of second segmented electrodes 230-dp included in the one sensing unit SU may be one, two, or four or more. Each of the first segmented electrodes 210-dp and the second segmented electrodes 230-dp may correspond to a resistance path or a signal transmitting path through which a signal is transmitted.

Referring to FIGS. 8 and 9A, the one fifth trace line 230rt2 is electrically connected to the one first electrode group 230pc. The one first electrode group 230pc may include the two third electrodes 230. In this case, the one fifth trace line 230rt2 may be electrically connected to sixth second segmented electrodes 230-dp. In this case, a degree to which the number of pads inside the sensor layer 200 is increased may be decreased.

As compared to a case in which the first electrode 210 inside the one sensing unit SU is not divided and has a single shape, when the first electrode 210 inside the one sensing unit SU includes the first segmented electrodes 210-dp, the first segmented electrodes 210-dp may be arranged inside the one sensing unit SU in a relatively uniform distribution. In this case, the signal may be uniformly provided inside the one sensing unit SU or the signal may be sensed.

Further, as compared to a case in which the first electrode 210 inside the one sensing unit SU is not divided, when the first electrode 210 inside the one sensing unit SU includes the first segmented electrodes 210-dp, the number of first bridge patterns 212 inside the one sensing unit SU may increase. FIG. 8A illustratively illustrates that, when the two first bridge patterns 212 connected to the same two first patterns 211 are considered as a pair, nine pairs of first bridge patterns 212 are arranged. That is, a total of 18 first bridge patterns 212 are illustrated.

For example, an increase in the number of first bridge patterns 212 arranged in the first direction DR1 intersecting the second direction DR2 that is an extension direction of the first electrode 210 may correspond to an increase in a signal path. Thus, as the number of signal paths is increased, a resistance of the first electrode 210 may be decreased. As a result, sensing sensitivity of the sensor layer 200 may be relatively improved.

Further, the shape of each of the first segmented electrodes 210-dp may be similar to a bar shape extending in the second direction DR2, and as the shape becomes more similar to the bar shape, a path of the resistance path may be shortened. Thus, when the path of the resistance path is shortened, and the number of resistance paths connected in parallel inside the one first electrode 210 is increased, the resistance of the first electrode 210 may be decreased. As a result, sensing sensitivity of the sensor layer 200 may be relatively improved.

Further, as the shape of each of the first segmented electrodes 210-dp becomes more similar to the bar shape extending in the second direction DR2, a ratio of an area that may be used in pattern design inside the entire area of the one sensing unit SU may be increased. Thus, the degree of freedom in the pattern design may be relatively improved.

According to some embodiments of the present disclosure, the degree of freedom in the pattern design of the sensing unit SU may be relatively improved, and the resistance of the electrode included in the sensing unit SU may be decreased. In this case, a frequency range (e.g., a bandwidth) applicable to the signal provided to the sensor layer 200 may be more advantageously secured. Thus, the degree of freedom in selecting a frequency may be relatively improved.

According to some embodiments of the present disclosure, each of the first patterns 211 may have a ring shape, and a portion of each of the second segmented electrodes 230-dp, which overlaps the first patterns 211, may be similar to a bar shape. In this case, an overlapping area between the first electrode 210 and the third electrode 230 may be easily adjusted by adjusting a size of an inner diameter of each of the first patterns 211, a width of each of the second segmented electrodes 230-dp, or the like.

According to some embodiments of the present disclosure, the first segmented electrode 210-dp may include the first patterns 211 and the first bridge patterns 212 arranged on different layers, and the first patterns 211 and the first bridge patterns 212 may be electrically connected through a contact. In this case, the resistance may be relatively increased as compared to a case in which the first patterns 211 and the first bridge patterns 212 are arranged on the same layer and integrally provided.

According to some embodiments of the present disclosure, a resistance of a portion of the second segmented electrode 230-dp, which overlaps the first pattern 211, may be lower than a resistance of the first pattern 211. However, this is merely an example, and a resistance relationship may be changed depending on a width of the ring of the first pattern 211 or a size of a width of the portion of the second segmented electrode 230-dp.

The second segmented electrode 230-dp may extend in the second direction DR2 inside the same layer. Thus, the resistance due to layer change inside the second segmented electrode 230-dp may not be increased. The second segmented electrode 230-dp may be an electrode to which a signal is applied in a charging drive mode, which will be described below. Thus, as the resistance of the second segmented electrode 230-dp is decreased, the intensities of a current and a magnetic field for charging a resonant circuit of the pen PN (see FIG. 4) may be increased.

According to some embodiments of the present disclosure, because the portion of each of the second segmented electrodes 230-dp, which overlaps the first patterns 211, is similar to the bar shape, the second segmented electrode 230-dp may have a shape of which a width is relatively smaller than that of the first segmented electrode 210-dp. In this case, a parasitic capacitance caused in each of the second segmented electrodes 230-dp may be decreased. Thus, performance of the sensor layer 200 may be relatively improved.

The plurality of third electrodes 230, a plurality of second patterns 241, and the plurality of first bridge patterns 212 may be arranged on the same layer.

The plurality of second electrodes 220, the plurality of first patterns 211, and a plurality of second bridge patterns 242 may be arranged on the same layer.

Referring to FIG. 9B, the second segmented electrode 230-dp may include a first part having a first width WT1 in the first direction DR1 and a second part having a second width WT2 in the first direction DR1. The first width WT1 may be greater than the second width WT2. For example, the first part having the first width WT1 may be closer to the first bridge patterns 212 than the second part having the second width WT2.

On a plane, the first part having the first width WT1 may overlap the first patterns 211 to form a capacitance. Further, the second part having the second width WT2 may overlap a dummy pattern surrounded by the first patterns 211. The overlapping area between the first electrode 210 and the third electrode 230 may be easily adjusted by adjusting the second width WT2.

An opening 230op may be defined in the second segmented electrode 230-dp, and the two first bridge patterns 212 may be arranged in the opening 230op. When the first bridge patterns 212 are surrounded by the second segmented electrode 230-dp, capacitances having values that change depending on temperatures among capacitances generated in the first electrode 210 may be decreased. Thus, temperature characteristics of the sensor layer 200 may be relatively improved.

The second electrode 220 may include a plurality of first branch parts 220b1 extending in the first direction DR1, a plurality of second branch parts 220b2 extending in the second direction DR2 intersecting the first direction DR1, and a connection part 220b3 located between the first patterns 211. The first branch parts 220b1 may be spaced apart from each other in the second direction DR2, and the second branch parts 220b2 may be spaced apart from each other in the first direction DR1. The first branch parts 220b1, the second branch parts 220b2, and the connection part 220b3 may be connected to each other to have an integral shape.

The fourth electrode 240 may include a plurality of third segmented electrodes 240-dp spaced apart from each other in the second direction DR2. Each of the third segmented electrodes 240-dp may extend in the first direction DR1. Each of the third segmented electrodes 240-dp may include the plurality of second patterns 241 and the plurality of second bridge patterns 242 electrically connected to the second patterns 241. Each of the second patterns 241 may have a ring shape. The second patterns 241 and the second bridge patterns 242 may be electrically connected to each other through contact holes defined in the intermediate insulating layer 203 (see FIG. 6). The two adjacent second patterns 241 may be spaced apart from each other with the one second segmented electrode 230-dp and the two first bridge patterns 212 interposed therebetween.

According to some embodiments of the present disclosure, a third width WT3 of the first branch parts 220b1 in the second direction DR2 may be greater than a fourth width WT4 of the second branch parts 220b2 in the first direction DR1. For example, the first branch parts 220b1 may overlap the second patterns 241 and a dummy pattern surrounded by the second patterns 241. An overlapping area between the second electrode 220 and the fourth electrode 240 may be easily adjusted by adjusting the third width WT3. Alternatively, the overlapping area between the second electrode 220 and the fourth electrode 240 may be easily adjusted by adjusting a size of an inner diameter of a ring shape surrounding the dummy pattern of each of the second patterns 241.

According to some embodiments of the present disclosure, each of the third segmented electrodes 240-dp may include the second patterns 241 and the second bridge patterns 242 arranged on different layers, and the second patterns 241 and the second bridge patterns 242 may be electrically connected through a contact. In this case, the resistance may be relatively increased as compared to a case in which the second patterns 241 and the second bridge patterns 242 are arranged on the same layer and integrally provided.

According to some embodiments of the present disclosure, the third electrode 230 corresponds to a component that transmits a signal when a touch is sensed or when the pen PN is sensed, and the fourth electrode 240 corresponds to a component that forms a capacitance with the third electrode 230 when the pen PN is sensed. Thus, it is more appropriate to reduce a resistance of the third electrode 230 than to reduce a resistance of the fourth electrode 240. Thus, the third electrode 230 may be implemented in the same one layer, and the fourth electrode 240 may be implemented in two different layers.

Referring to FIGS. 9A and 9B, the second bridge pattern 242 may include only one line extending in a first intersection direction CDR1 or a second intersection direction CDR2 in a partial section. In this case, the first bridge patterns 212 overlapping the second bridge patterns 242 may be insulated from and intersect each other in the partial section. In this case, a capacitance between the first bridge pattern 212 and the second bridge pattern 242 may be minimized.

Referring to FIGS. 9B and 10B, each of the second segmented electrodes 230-dp, the second patterns 241, the first patterns 211, the second electrode 220, and the second bridge patterns 242 may have a mesh structure. Each of the mesh structures may include a plurality of mesh lines. Each of the plurality of mesh lines may have a shape extending in a direction (e.g., a set or predetermined direction), and the mesh lines may be connected to each other. The shape may be various shapes such as a straight line, a line having a protrusion, and an uneven line. Openings at least partially surrounded by the mesh lines may be defined (provided or formed) in each of the mesh structures. The openings may overlap the light emitting area PXA (see FIG. 6), and the mesh lines may overlap the non-light emitting area NPXA (see FIG. 6). However, embodiments according to the present disclosure are not particularly limited thereto.

FIGS. 9B and 10B illustratively illustrate that the mesh structure includes mesh lines extending in the first intersection direction CDR1 that intersects the first direction DR1 and the second direction DR2 and mesh lines extending in the second intersection direction CDR2 that intersects the first intersection direction CDR1. However, the extension directions of the mesh lines constituting the mesh structure are not particularly limited to the illustration of FIGS. 9B and 10B. For example, the mesh structure may include only mesh lines extending in the first direction DR1 and the second direction DR2 or may include mesh lines extending in the first direction DR1, the second direction DR2, the first intersection direction CDR1, and the second intersection direction CDR2. That is, the mesh structure may be changed into various forms.

According to some embodiments of the present disclosure, a first capacitance may be defined between the first electrode 210 and the third electrode 230, and a second capacitance may be defined between the second electrode 220 and the fourth electrode 240. A magnitude of the first capacitance and a magnitude of the second capacitance may be adjusted by the overlapping area between the first electrode 210 and the third electrode 230 and the overlapping area between the second electrode 220 and the fourth electrode 240.

As the first capacitance and the second capacitance are increased, the amount of induced current transmitted from the third electrode 230 to the first electrode 210 may be increased, and the amount of induced current transmitted from the fourth electrode 240 to the second electrode 220 may be increased. Thus, as the first capacitance and the second capacitance are increased, pen sensing performance of the sensor layer 200 may be relatively improved. Further, the first capacitance and the second capacitance may act as loads when the touch is sensed. Thus, as the first capacitance and the second capacitance are decreased, touch sensing performance may be relatively improved.

According to the present disclosure, the overlapping area between the first electrode 210 and the third electrode 230 and the overlapping area between the second electrode 220 and the fourth electrode 240 may be easily adjusted. Thus, the sensor layer 200 having appropriate capacitances considering touch sensitivity and pen sensing sensitivity may be provided. As a result, the electronic device ED (see FIG. 5) having both improved pen sensitivity and improved touch sensitivity may be provided.

According to some embodiments of the present disclosure, in the second conductive layer 204 inside the one sensing unit SU, an area occupied by components included in the first electrode 210 and the second electrode 220 may be larger than an area occupied by components included in the third electrode 230 and the fourth electrode 240. A change in the capacitance due to the first input 2000 (see FIG. 4) may be greater as a distance therefrom becomes shorter. Thus, a component for sensing the first input 2000 (see FIG. 4) may be located in a relatively larger area in a layer adjacent to a surface of the electronic device ED (see FIG. 5). As a result, touch performance may be relatively improved.

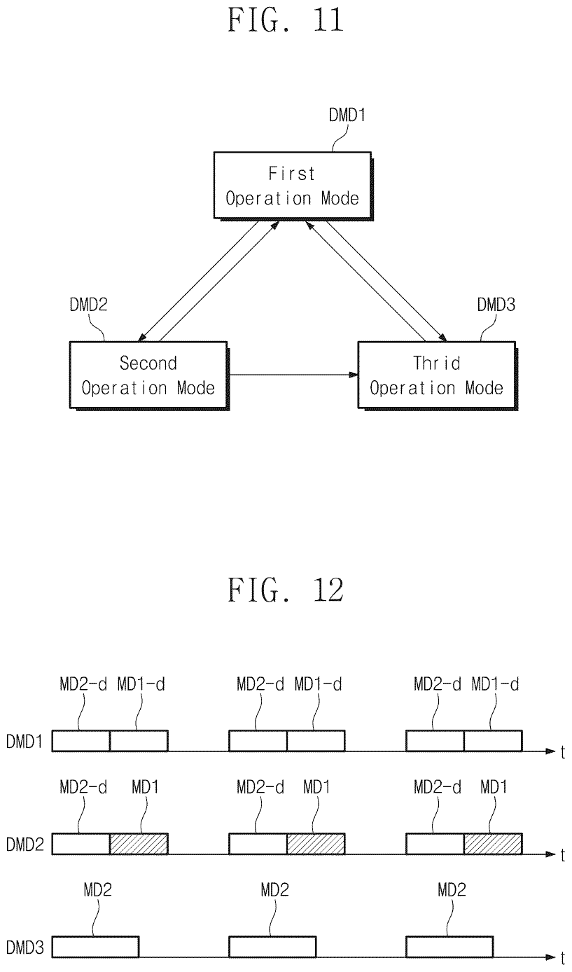

FIG. 11 is a view illustrating an operation of a sensor driving unit according to some embodiments of the present disclosure.

Referring to FIGS. 4 and 11, the sensor driving unit 200C may be configured to be selectively driven in one of a first operation mode DMD1, a second operation mode DMD2, and a third operation mode DMD3.

The first operation mode DMD1 may be referred to as a touch and pen waiting mode, the second operation mode DMD2 may be referred to as a touch activation and pen waiting mode, and the third operation mode DMD3 may be referred to as a pen activation mode. The first operation mode DMD1 may be a mode that waits for the first input 2000 and the second input 3000. The second operation mode DMD2 may be a mode that senses the first input 2000 and waits for the second input 3000. The third operation mode DMD3 may be a mode that senses the second input 3000.

According to some embodiments of the present disclosure, the sensor driving unit 200C may be first driven in the first operation mode DMD1. When the first input 2000 is sensed in the first operation mode DMD1, the sensor driving unit 200C may be switched (or changed) to the second operation mode DMD2. Alternatively, when the second input 3000 is sensed in the first operation mode DMD1, the sensor driving unit 200C may be switched (or changed) to the third operation mode DMD3.

According to some embodiments of the present disclosure, when the second input 3000 is sensed in the second operation mode DMD2, the sensor driving unit 200C may be switched to the third operation mode DMD3. When the first input 2000 is released (or not sensed) in the second operation mode DMD2, the sensor driving unit 200C may be switched to the first operation mode DMD1. When the second input 3000 is released (or not sensed) in the third operation mode DMD3, the sensor driving unit 200C may be switched to the first operation mode DMD1.

FIG. 12 is a view illustrating the operation of the sensor driving unit according to some embodiments of the present disclosure.

FIGS. 4, 8, 11, and 12 illustratively illustrate operations in the first operation mode DMD1, the second operation mode DMD2, and the third operation mode DMD3 in an order of a time “t.”

In the first operation mode DMD1, the sensor driving unit 200C may be repeatedly driven in a second mode MD2-d and a first mode MD1-d. During the second mode MD2-d, the sensor layer 200 may be scan-driven to detect the second input 3000. During the first mode MD1-d, the sensor layer 200 may be scan-driven to detect the first input 2000. FIG. 12 illustratively illustrates that the sensor driving unit 200C is continuously operated in the first mode MD1-d after the second mode MD2-d, but an order thereof is not limited thereto.

In the second operation mode DMD2, the sensor driving unit 200C may be repeatedly driven in the second mode MD2-d and a first mode MD1. During the second mode MD2-d, the sensor layer 200 may be scan-driven to detect the second input 3000. During the first mode MD1, the sensor layer 200 may be scan-driven to detect coordinates by the first input 2000.

In the third operation mode DMD3, the sensor driving unit 200C may be driven in a second mode MD2. During the second mode MD2, the sensor layer 200 may be scan-driven to detect coordinates by the second input 3000. In the third operation mode DMD3, the sensor driving unit 200C may not be operated in the first mode MD1-d or MD1 until the second input 3000 is released (or not sensed).

In the first mode MD1-d and the first mode MD1, all the third electrodes 230 and the fourth electrodes 240 may be grounded or a constant voltage may be applied thereto. Alternatively, in the first mode MD1-d and the first mode MD1, all the third electrodes 230 and the fourth electrodes 240 may be floating (or electrically floating). Alternatively, in the first mode MD1-d and the first mode MD1, a signal having the same phase as a transmission signal provided to the first electrodes 210 may be applied to the third electrodes 230 and the fourth electrodes 240. In this case, touch noise may be prevented from being introduced through the third electrodes 230 and the fourth electrodes 240.

In the second mode MD2-d and the second mode MD2, one end of each of the third electrodes 230 and the fourth electrodes 240 may be floating. Further, in the second mode MD2-d and the second mode MD2, all the other ends of the third electrodes 230 and the fourth electrodes 240 may be grounded or floating. Thus, compensation for the sensing signal may be maximized by coupling between the first electrodes 210 and the third electrodes 230 and coupling between the second electrodes 220 and the fourth electrodes 240.

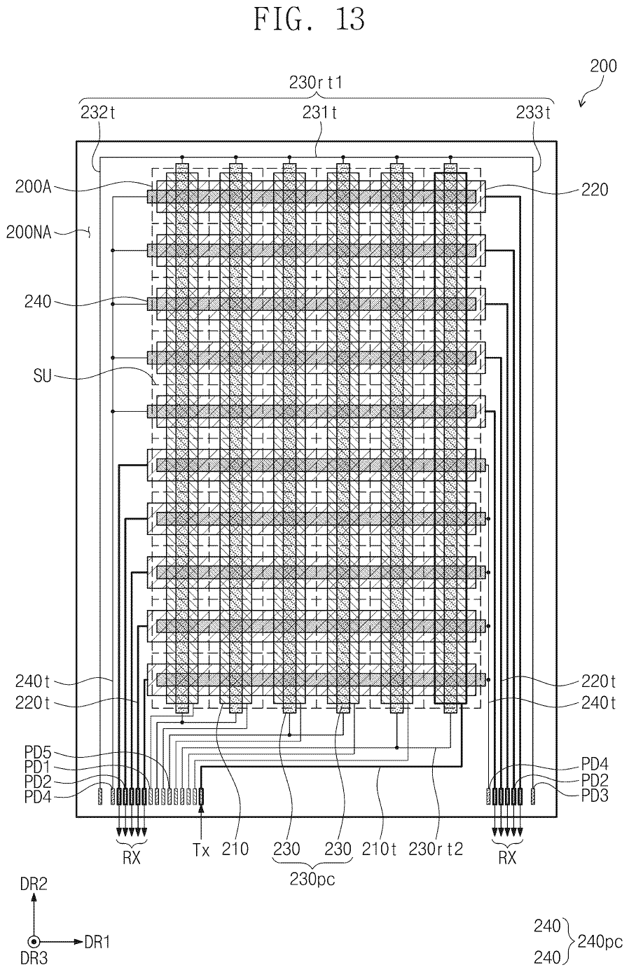

FIG. 13 is a view for describing a first mode according to some embodiments of the present disclosure. In the description of FIG. 13, the components described through FIG. 8 are designated by the same reference numerals, and a description thereof will be omitted.

Referring to FIGS. 4, 12, and 13, the first mode MD1-d of the first operation mode DMD1 and the first mode MD1 of the second operation mode DMD2 may include a mutual capacitance detecting mode. FIG. 13 is a view for describing the mutual capacitance detecting mode in the first mode MD1-d of the first operation mode DMD1 and the first mode MD1 of the second operation mode DMD2.

In the mutual capacitance detecting mode, the sensor driving unit 200C may sequentially provide a transmission signal TX to the first electrodes 210 and detect coordinates for the first input 2000 using a reception signal RX detected through the second electrodes 220. For example, the sensor driving unit 200C may calculate input coordinates by sensing a change in a mutual capacitance between the first electrodes 210 and the second electrodes 220.

FIG. 13 illustratively expresses that the transmission signal TX is provided to the one first electrode 210 and the reception signal RX is output from the second electrodes 220. To clarify the expression of the signal, in FIG. 13, the one first electrode 210 to which the transmission signal TX is provided is indicated in bold. The sensor driving unit 200C may detect input coordinates for the first input 2000 by sensing the change in the capacitance between the first electrodes 210 and the second electrodes 220.

According to some embodiments of the present disclosure, at least one of the first mode MD1-d of the first operation mode DMD1 or the first mode MD1 of the second operation mode DMD2 may further include a self-capacitance detecting mode. In the self-capacitance detecting mode, the sensor driving unit 200C may output driving signals to the first electrodes 210 and the second electrodes 220 and calculate input coordinates by sensing the change in the capacitance between the first electrodes 210 and the second electrodes 220.

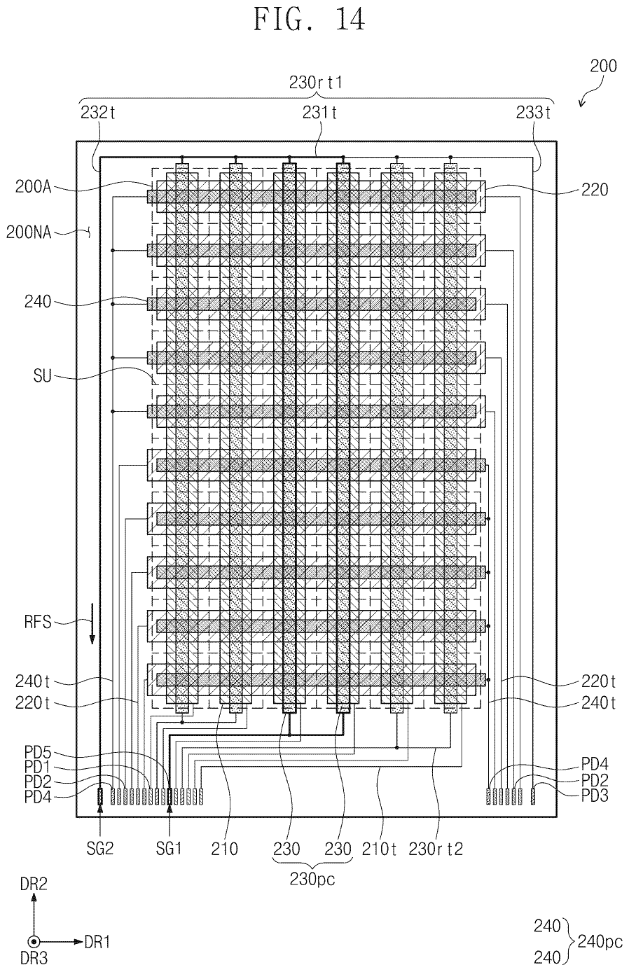

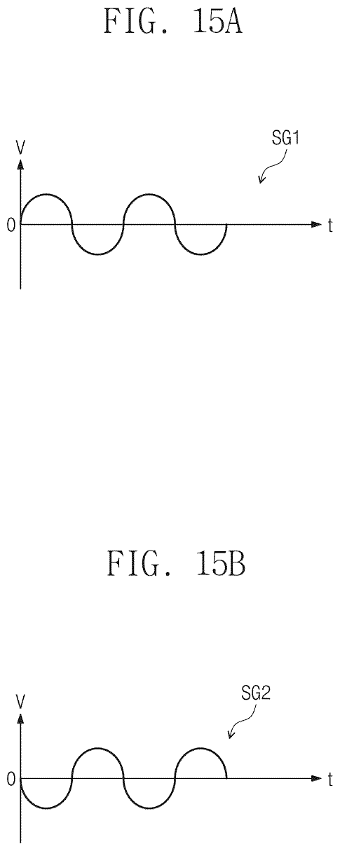

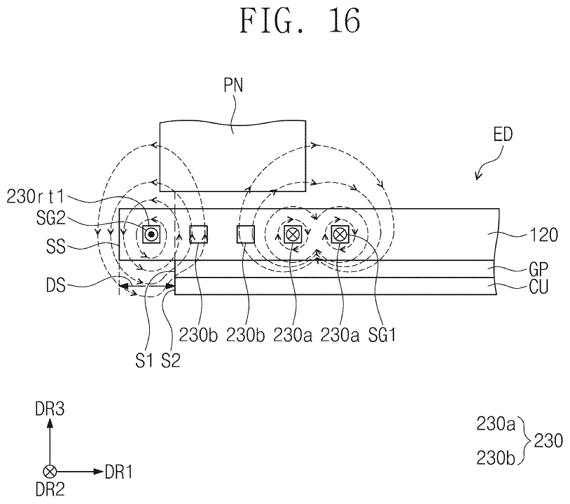

FIG. 14 is a view for describing a second mode according to some embodiments of the present disclosure, FIG. 15A is a graph depicting a waveform of a first signal according to some embodiments of the present disclosure, and FIG. 15B is a graph depicting a waveform of a second signal according to some embodiments of the present disclosure. In the description of FIG. 14, the components described through FIG. 8 are designated by the same reference numerals, and a description thereof will be omitted.

Referring to FIGS. 14, 15A, and 15B, the second mode MD2 may include the charging drive mode. The charging drive mode may include a searching charging drive mode and a tracking charging drive mode.

The searching charging drive mode may be a drive mode before a position of the pen is sensed. Thus, a first signal SG1 or a second signal SG2 may be sequentially provided to all channels included in the sensor layer 200. That is, in the searching charging drive mode, the entire area of the sensor layer 200 may be sequentially scanned. In the searching charging drive mode, when the pen PN is sensed, the sensor layer 200 may be driven for tracking charging. For example, in the tracking charging drive mode, the sensor driving unit 200C may sequentially output the first signal SG1 and the second signal SG2 to an area overlapping a point at which the pen PN is sensed rather than the entire sensor layer 200.

In the charging drive mode, the sensor driving unit 200C may apply the first signal SG1 to one pad among the third pads PD3 and the fifth pads PD5 and apply the second signal SG2 to the other one pad. The second signal SG2 may be an inverse signal of the first signal SG1. For example, the first signal SG1 may be a sinusoidal signal.

Because the first signal SG1 and the second signal SG2 are applied to at least two pads, a current RFS may have a current path flowing to the other one pad through the one pad. Further, because the first signal SG1 and the second signal SG2 are sinusoidal signals having an inverse phase relationship, a direction of the current RFS may be changed periodically. According to some embodiments of the present disclosure, the first signal SG1 and the second signal SG2 may be square wave signals having an inverse phase relationship.

When the first signal SG1 and the second signal SG2 have the inverse phase relationship, noise caused in the display layer 100 (see FIG. 4) by the first signal SG1 may be canceled with noise caused by the second signal SG2. Thus, a flicker phenomenon may not occur in the display layer 100, and display quality of the display layer 100 may be relatively improved.

According to some embodiments of the present disclosure, the first signal SG1 may be a sinusoidal signal. However, embodiments according to the present disclosure are not limited thereto, and the first signal SG1 may be a square wave signal. Further, the second signal SG2 may have a constant voltage (e.g., a set or predetermined constant voltage). For example, the second signal SG2 may be a ground voltage. That is, the pad to which the second signal SG2 is applied may be considered as being grounded. Even in this case, the current RFS may flow from the one pad to the other one pad. Further, even when the other one pad is grounded, the first signal SG1 is a sinusoidal wave signal or a square wave signal, and thus the direction of the current RFS may be changed periodically.

It is illustrated that the second signal SG2 is provided to the one third pad PD3 connected to the one third trace line 230rt1 and the first signal SG1 is provided to the one fifth pad PD5 connected to the third electrode 230. The current RFS may flow through a current path defined by the fifth pad PD5, the fifth trace line 230rt2 connected to the fifth pad PD5, the third electrode 230, a portion of the third trace line 230rt1 connected to the third pad PD3, and the third pad PD3. The current path may have a coil shape. Thus, in the charging drive mode of the second mode, the resonant circuit of the pen PN may be charged by the current path.

According to the present disclosure, the current path having a loop coil pattern may be implemented by components included in the sensor layer 200. Thus, the electronic device ED (see FIG. 3) may charge the pen PN using the sensor layer 200. Thus, because it may not be necessary to separately add a component having a coil for charging the pen PN, an increase in a thickness, an increase in a weight, and a decrease in flexibility of the electronic device ED (see FIG. 3) may not occur.

In the charging drive mode, the first electrodes 210, the second electrodes 220, and the fourth electrodes 240 may be grounded or electrically floating, or a constant voltage may be applied thereto. For example, the first electrodes 210, the second electrodes 220, and the fourth electrodes 240 may be floating. In this case, the current RFS may not flow through the first electrodes 210, the second electrodes 220, and the fourth electrodes 240.

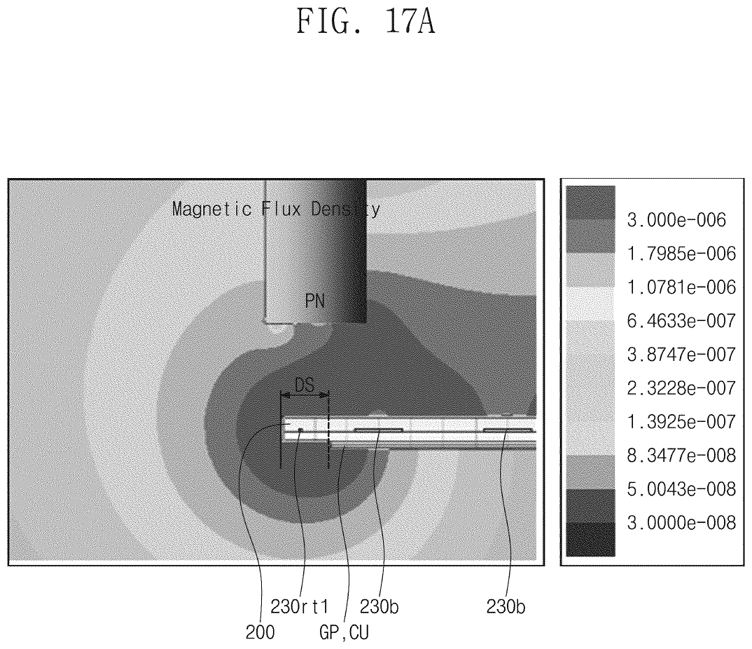

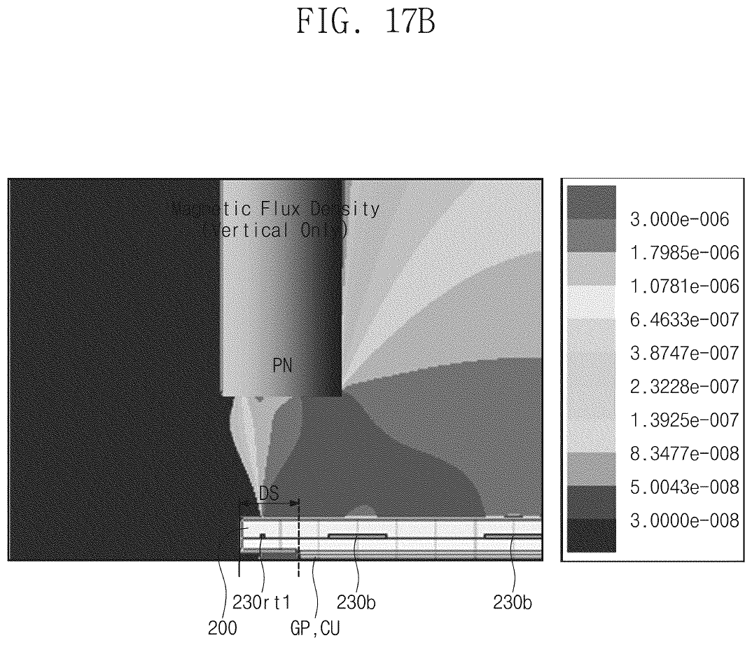

FIG. 16 is a schematic cross-sectional view illustrating the electronic device and a pen according to some embodiments of the present disclosure, FIG. 17A illustrates a magnetic flux density of a magnetic field according to some embodiments of the present disclosure, and FIG. 17B illustrates a vertical magnetic flux density of the magnetic field according to some embodiments of the present disclosure. In the description of FIG. 16, the components described through FIG. 5 are designated by the same reference numerals, and a description thereof will be omitted.

Referring to FIGS. 14 to 17B, the first side surface S1 of the magnetic layer GP and the second side surface S2 of the shielding layer CU may be arranged between the third trace line 230rt1 and the third electrode 230 adjacent to the third trace line 230rt1. The third electrode 230 adjacent to the third trace line 230rt1 may be the third electrode 230 located at an outermost portion of the active area 200A (see FIG. 8) among the plurality of third electrodes 230.

The magnetic layer GP and the shielding layer CU may be spaced a separation distance DS from the side surface SS of the sensor layer 200 toward the center of the sensor layer 200.

The plurality of third electrodes 230 may include (3-1)^{th} electrodes 230a and (3-2)^{th} electrodes 230b.

The (3-2)^{th} electrodes 230b may be arranged between the third trace line 230rt1 and the (3-1)^{th} electrodes 230a. The third trace line 230rt1 and the (3-1)^{th} electrodes 230a may define a loop coil pattern.

In the charging drive mode, the first signal SG1 may be provided to the two (3-1)^{th} electrodes 230a, and the second signal SG2 may be provided to the third trace line 230rt1.

In the charging drive mode, the current RFS may flow in the (3-1)^{th} electrodes 230a in the second direction DR2, and the current RFS (see FIG. 14) may flow in the third trace line 230rt1 in a direction opposite to the second direction DR2.

The magnetic field may be generated by the current RFS (see FIG. 14). When the pen PN is located at an edge portion of the electronic device ED, the resonant circuit of the pen PN may be charged by the magnetic field.

A first magnetic field generated by the (3-1)^{th} electrodes 230a may be controlled by the magnetic layer GP to face the pen PN. The magnetic flux path of the first magnetic field may be changed by the magnetic layer GP.

The first magnetic field may be shielded by the shielding layer CU. The shielding layer CU may prevent, reduce, or remove the first magnetic field provided under the shielding layer CU.

According to the present disclosure, the electronic device ED may include the magnetic layer GP and the shielding layer CU arranged under the sensor layer 200. The magnetic layer GP may change the magnetic flux path of the magnetic field generated in the sensor layer 200, and the shielding layer CU may perform a control to prevent the magnetic field from being transmitted to a lower side of the shielding layer CU. Electromagnetic wave interference that may occur in electronic modules arranged under the shielding layer CU may be prevented, reduced, or removed. Therefore, the electronic device ED having improved reliability may be provided.

A second magnetic field generated by the third trace line 230rt1 may not be shielded by the shielding layer CU. In the edge portion of the electronic device ED, the second magnetic field is shielded less than the first magnetic field, and thus the amount of the magnetic field radiated toward the pen PN may be increased.

Unlike the present disclosure, according to some embodiments, the magnetic layer and the shielding layer may completely cover the sensor layer. In the edge portion of the electronic device ED, the magnetic field generated by the third trace line 230rt1 may be shielded by the shielding layer. However, according to the present disclosure, the first side surface S1 of the magnetic layer GP and the second side surface S2 of the shielding layer CU may be arranged between the third trace line 230rt1 and the outermost third electrode 230b. The magnetic layer GP and the shielding layer CU may not cover at least a portion of an edge portion of the sensor layer 200. The magnetic field generated by the third trace line 230rt1 may be provided to the pen PN via a lower portion of the sensor layer 200 in the edge portion of the electronic device ED. Accordingly, density of the magnetic field may be increased and vertical magnetic field density may be increased. The magnetic flux density of the electronic device ED may be increased by about 74% in the edge portion compared to some embodiments. Thus, the electronic device ED having improved pen charging performance in the edge portion may be provided.

Further, according to the present disclosure, in the edge portion of the electronic device ED, the density of the magnetic field may be increased and the vertical magnetic field density may be increased. Accordingly, the amount of the magnetic field provided to the pen PN in the edge portion may be increased. In the charging drive mode, charging performance of the resonant circuit of the pen PN may be relatively improved. Accordingly, the resonant circuit may have improved discharge performance. The resonant circuit may emit a pen magnetic field having a resonant frequency while discharging the charged charge. The induced current may be generated in the sensor layer 200 by the pen magnetic field provided from the pen PN. Sensing sensitivity of the sensor layer 200 with respect to the pen PN may be relatively improved. Thus, the electronic device ED having improved pen sensing performance may be provided.

The sensor layer 200, the magnetic layer GP, and the shielding layer CU may be accommodated by the housing HOU (see FIG. 3). A first resistance of the shielding layer CU may be lower than a second resistance of the housing HOU (see FIG. 3).

According to the present disclosure, the housing HOU (see FIG. 3) may generate less eddy current than the shielding layer CU. The second magnetic field may be shielded by the housing HOU (see FIG. 3) and thus prevented from being not provided toward the pen PN. Therefore, the electronic device ED having improved reliability may be provided.

A minimum value of the separation distance DS may be a distance from the side surface SS to the third trace line 230rt1, and a maximum value of the separation distance DS may be a distance from the side surface SS to the third electrode 230 adjacent to the third trace line 230rt1. The separation distance DS may be in a range of 1 mm to 3 mm. For example, the separation distance DS may be about 1.5 mm.

Unlike the present disclosure, when the separation distance DS is smaller than the minimum value, the second magnetic field generated in the third trace line 230rt1 in the edge portion of the electronic device ED may be shielded by the shielding layer CU. Alternatively, when the separation distance DS is greater than the maximum value, the first magnetic field generated in the third electrodes 230 may not be shielded by the shielding layer CU. Malfunction and sensing quality degradation of the sensor layer 200 may occur due to interference by electromagnetic waves such as electromagnetic interference (EMI) and electromagnetic compatibility (EMC). However, according to the present disclosure, the magnetic layer GP and the shielding layer CU may not cover at least the portion of the edge portion of the sensor layer 200. The magnetic field generated by the third trace line 230rt1 may be provided to the pen PN via the lower portion of the sensor layer 200 in the edge portion of the electronic device ED. Accordingly, the density of the magnetic field may be increased and the vertical magnetic field density may be increased. Thus, the electronic device ED having improved pen sensing performance may be provided.

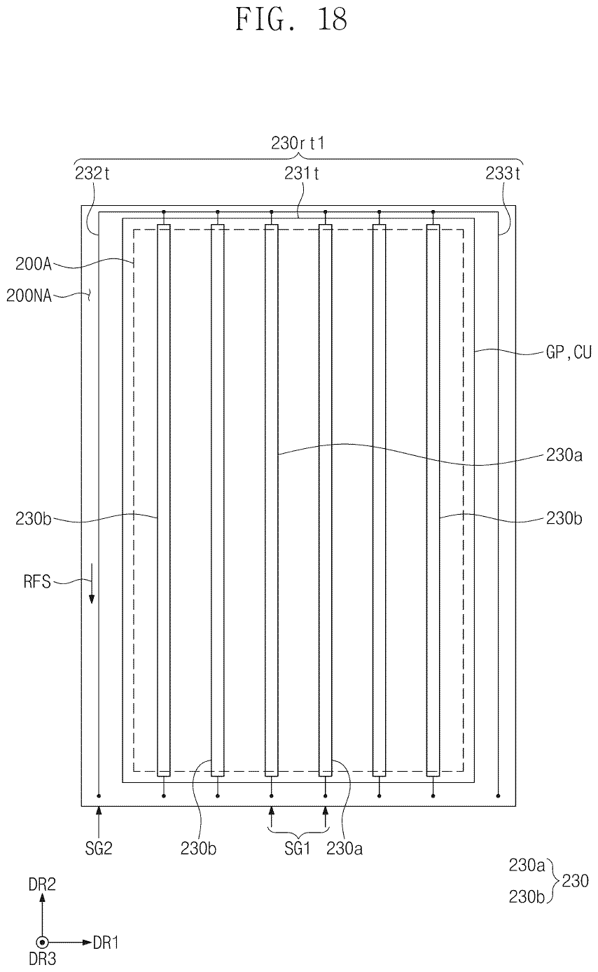

FIG. 18 is a plan view illustrating the sensor layer, a magnetic layer, and a shielding layer according to some embodiments of the present disclosure. In the description of FIG. 18, the components described through FIG. 8 are designated by the same reference numerals, and a description thereof will be omitted.

Referring to FIGS. 16 and 18, when viewed on a plane (e.g., in a plan view), an area of the sensor layer 200 may be larger than an area of each of the magnetic layer GP and the shielding layer CU.

The plurality of third electrodes 230 may overlap the magnetic layer GP and the shielding layer CU. The third trace line 230rt1 may not overlap the magnetic layer GP and the shielding layer CU.

Each of the plurality of third electrodes 230 may be connected to the third trace line 230rt1.

In the charging drive mode, the first signal SG1 may be provided to the two (3-1)^{th} electrodes 230a, and the second signal SG2 may be provided to the third trace line 230rt1.

The third trace line 230rt1 and the (3-1)^{th} electrodes 230a may define a loop coil pattern. The current RFS may flow in the loop coil pattern.

When viewed on a plane (e.g., in a plan view), a partial area of the loop coil pattern responsible for charging the pen PN in the edge portion of the electronic device ED may not overlap the magnetic layer GP and the shielding layer CU. Accordingly, the magnetic field provided to the pen PN in the edge portion may be increased.

The magnetic field may be generated by the current RFS. When the pen PN is located at the edge portion of the electronic device ED, the resonant circuit of the pen PN may be charged by the magnetic field.

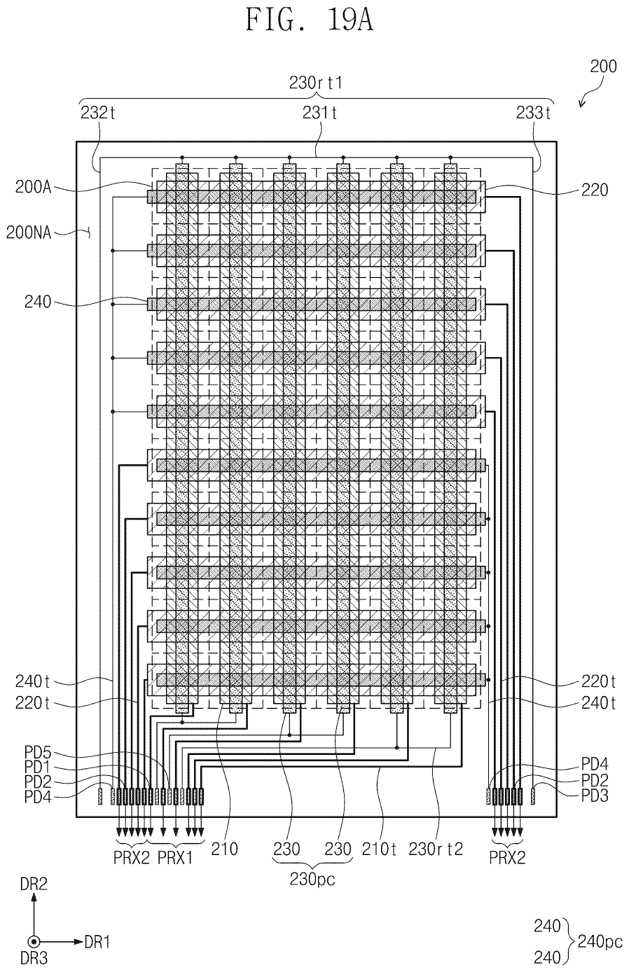

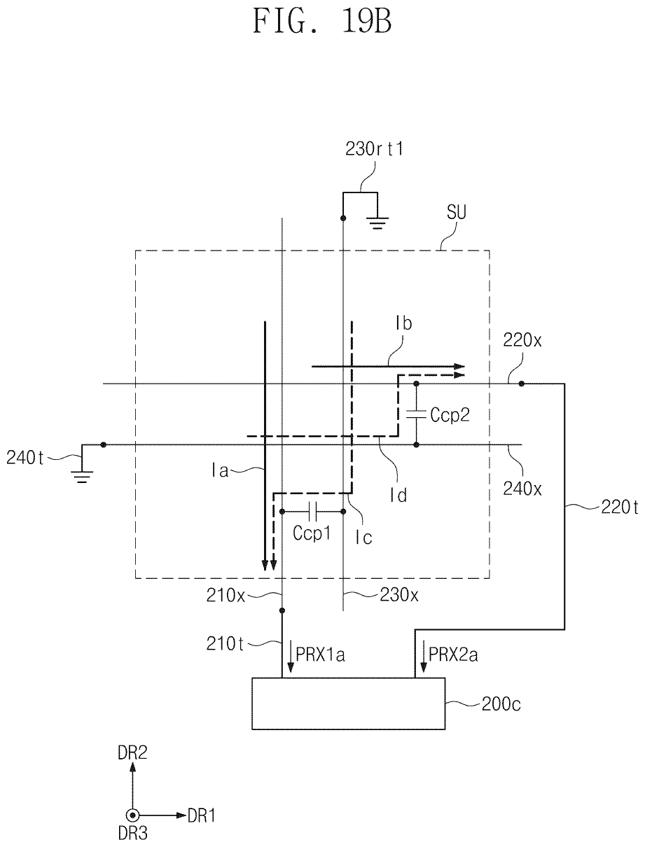

FIG. 19A is a view for describing the second mode according to some embodiments of the present disclosure, and FIG. 19B is a view for describing the second mode based on the one sensing unit according to some embodiments of the present disclosure.

Referring to FIGS. 19A and 19B, the second mode may include the charging drive mode and a pen sensing drive mode. FIGS. 19A and 19B are views for describing the pen sensing drive mode. FIG. 19B illustrates the one sensing unit SU through which a first induced current Ia, a second induced current Ib, a third induced current Ic, and a fourth induced current Id generated by the pen PN flow.

According to some embodiments of the present disclosure, routing directions of the one electrode and the other one electrode of the sensor layer 200, which overlap each other, may be different from each other. For example, a routing direction of a first electrode 210x and a routing direction of a third electrode 230x may be different from each other. Further, a routing direction of a second electrode 220x and a routing direction of a fourth electrode 240x may be different from each other. For example, in FIG. 19B, the first electrode 210x and the first trace line 210t may be connected to each other on a lower side of the sensing unit SU, and the third electrode 230x and the third trace line 230rt1 may be connected to each other on an upper side of the sensing unit SU. The second electrode 220x and the second trace line 220t may be connected to each other on a right side of the sensing unit SU, and the fourth electrode 240x and the fourth trace line 240t may be connected to each other on a left side of the sensing unit SU.

The RLC resonant circuit of the pen PN may emit a magnetic field having a resonant frequency while discharging the charged charges. By the magnetic field provided in the pen PN, the first induced current Ia may be generated in the first electrode 210x, and the second induced current Ib may be generated in the second electrode 220x. Further, the third induced current Ic may be generated in the third electrode 230x, and the fourth induced current Id may be generated in the fourth electrode 240x.

A first coupling capacitor Ccp1 may be formed between the third electrode 230x and the first electrode 210x, and a second coupling capacitor Ccp2 may be formed between the fourth electrode 240x and the second electrode 220x. The third induced current Ic may be transmitted to the first electrode 210x through the first coupling capacitor Ccp1, and the fourth induced current Id may be transmitted to the second electrode 220x through the second coupling capacitor Ccp2.

The sensor driving unit 200C may receive, from the first electrode 210x, a first reception signal PRX1a based on the first induced current Ia and the third induced current Ic and may receive, from the second electrode 220x, a second reception signal PRX2a based on the second induced current Ib and the fourth induced current Id. The sensor driving unit 200C may detect the input coordinates of the pen PN based on the first reception signal PRX1a and the second reception signal PRX2a.

According to the present disclosure, when the input coordinates are detected using a differential sensing method, an outermost x-axis coordinate of the electronic device ED may be determined according to a difference between magnitudes of signals received from the first first electrode 210 and the third first electrode 210. In the edge portion of the electronic device ED, the density of the magnetic field may be increased and the vertical magnetic field density may be increased. Accordingly, the amount of the magnetic field provided to the pen PN in the edge portion may be increased. In the charging drive mode, the charging performance of the resonant circuit of the pen PN may be relatively improved. Accordingly, the resonant circuit may have improved discharge performance. The resonant circuit may emit the pen magnetic field having the resonant frequency while discharging the charged charge. The magnitude of the signal received from the first first electrode 210 may be increased. Accordingly, sensing sensitivity of the sensor layer 200 with respect to the pen PN may be relatively improved. Thus, the electronic device ED having improved sensing performance may be provided.

The sensor driving unit 200C may receive the first reception signal PRX1a from the first electrode 210x and may receive the second reception signal PRX2a from the second electrode 220x. In this case, one ends of the third electrode 230x and the fourth electrode 240x may be floating. Thus, compensation for the sensing signal may be maximized by coupling between the first electrode 210x and the third electrode 230x and coupling between the second electrode 220x and the fourth electrode 240x.

Further, the other ends of the third electrode 230x and the fourth electrode 240x may be grounded or floating. Thus, the third induced current Ic and the fourth induced current Id may be sufficiently transmitted to the first electrode 210x and the second electrode 220x by the coupling between the first electrode 210x and the third electrode 230x and the coupling between the second electrode 220x and the fourth electrode 240x.

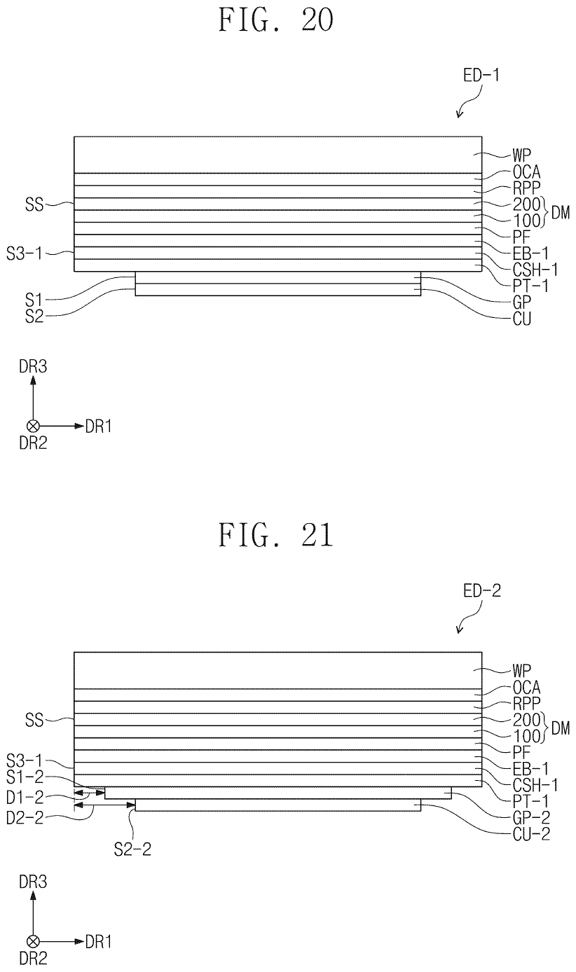

FIG. 20 is a schematic cross-sectional view of the electronic device according to some embodiments of the present disclosure. In the description of FIG. 20, the components described through FIG. 5 are designated by the same reference numerals, and a description thereof will be omitted.

Referring to FIG. 20, an electronic device ED-1 may include the window WP, the adhesive layer OCA, the reflection preventing layer RPP, the display module DM, the protective layer PF, an embossed layer EB-1, a cushion layer CSH-1, a reinforcing layer PT-1, the magnetic layer GP, and the shielding layer CU.

A third side surface S3-1 of each of the cushion layer CSH-1 and the embossed layer EB-1 may be aligned with the side surface SS of the sensor layer 200.

The first side surface S1 of the magnetic layer GP and the second side surface S2 of the shielding layer CU may be arranged closer to a center of the sensor layer 200 than the third side surface S3-1.

When viewed on a plane (e.g., in a plan view), an area of the sensor layer 200 may be the same (or substantially the same) as an area of each of the cushion layer CSH-1 and the embossed layer EB-1. When viewed on a plane (e.g., in a plan view), the cushion layer CSH-1 and the embossed layer EB-1 may completely cover the sensor layer 200.

When viewed on a plane (e.g., in a plan view), the area of each of the magnetic layer GP and the shielding layer CU may be smaller than the area of each of the cushion layer CSH-1 and the embossed layer EB-1.

According to the present disclosure, in an edge portion of the electronic device ED-1, the density of the magnetic field may be increased and the vertical magnetic field density may be increased. Accordingly, the amount of the magnetic field provided to the pen PN (see FIG. 4) in the edge portion may be increased. In the charging drive mode, the charging performance of the resonant circuit of the pen PN (see FIG. 4) may be relatively improved. Accordingly, the resonant circuit may have improved discharge performance. The resonant circuit may emit a pen magnetic field having a resonant frequency while discharging the charged charge. The induced current may be generated in the sensor layer 200 by the pen magnetic field provided from the pen PN (see FIG. 4). The sensing sensitivity of the sensor layer 200 with respect to the pen PN (see FIG. 4) may be relatively improved. Thus, the electronic device ED-1 having improved sensing performance may be provided.

FIG. 21 is a schematic cross-sectional view of the electronic device according to some embodiments of the present disclosure. In the description of FIG. 21, the components described through FIG. 20 are designated by the same reference numerals, and a description thereof will be omitted.

Referring to FIG. 21, an electronic device ED-2 may include the window WP, the adhesive layer OCA, the reflection preventing layer RPP, the display module DM, the protective layer PF, the embossed layer EB-1, the cushion layer CSH-1, the reinforcing layer PT-1, a magnetic layer GP-2, and a shielding layer CU-2.

A first side surface S1-2 of the magnetic layer GP-2 may be spaced a first distance D1-2 from the side surface SS of the sensor layer 200 toward the center of the sensor layer 200.

A second side surface S2-2 of the shielding layer CU-2 may be spaced a second distance D2-2 from the side surface SS of the sensor layer 200 toward the center of the sensor layer 200.

The first distance D1-2 may be different from the second distance D2-2. The first distance D1-2 may be smaller than the second distance D2-2. However, this is illustrative, and a relationship between the first distance D1-2 and the second distance D2-2 according to some embodiments of the present disclosure is not limited thereto. For example, the first distance D1-2 may be greater than the second distance D2-2.

According to the present disclosure, in an edge portion of the electronic device ED-2, the density of the magnetic field may be increased and the vertical magnetic field density may be increased. Accordingly, the amount of the magnetic field provided to the pen PN (see FIG. 4) in the edge portion may be increased. In the charging drive mode, the charging performance of the resonant circuit of the pen PN (see FIG. 4) may be relatively improved. Accordingly, the resonant circuit may have improved discharge performance. The resonant circuit may emit the pen magnetic field having the resonant frequency while discharging the charged charge. The induced current may be generated in the sensor layer 200 by the pen magnetic field provided from the pen PN (see FIG. 4). The sensing sensitivity of the sensor layer 200 with respect to the pen PN (see FIG. 4) may be relatively improved. Thus, the electronic device ED-2 having improved sensing performance may be provided.

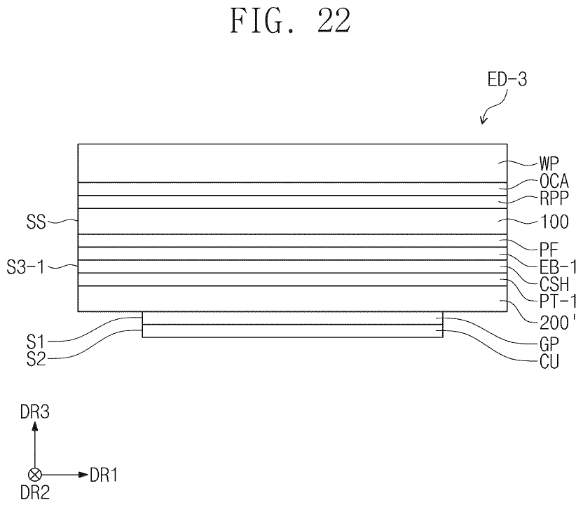

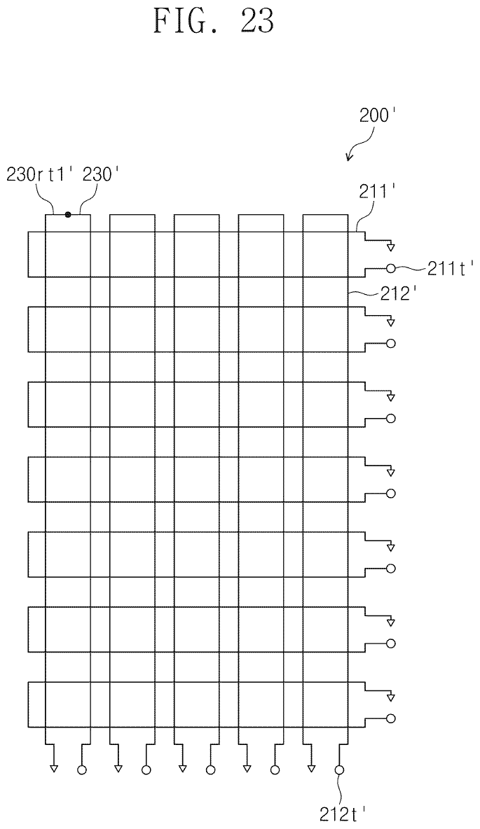

FIG. 22 is a schematic cross-sectional view of the electronic device according to some embodiments of the present disclosure, and FIG. 23 is a view briefly illustrating some components of the electronic device according to some embodiments of the present disclosure. In the description of FIG. 22, the components described through FIG. 20 are designated by the same reference numerals, and a description thereof will be omitted.

Referring to FIGS. 22 and 23, an electronic device ED-3 may include the window WP, the adhesive layer OCA, the reflection preventing layer RPP, a display layer 100, the protective layer PF, the embossed layer EB-1, the cushion layer CSH-1, the reinforcing layer PT-1, a digitizer 200′, the magnetic layer GP, and the shielding layer CU.

The digitizer 200′ may be located between the display layer 100 and the magnetic layer GP. The digitizer 200′ may be located under the reinforcing layer PT-1. The digitizer 200′ may sense an input of the pen PN (see FIG. 4).

The digitizer 200′ may include a plurality of first coils 211′ and a plurality of second coils 212′. The first coils 211′ may be referred to as driving coils, and the second coils 212′ may be referred to as sensing coils or crossing coils.

The first coils 211′ may be arranged to be insulated from and cross the second coils 212′. Alternating current (AC) signals are sequentially provided to first terminals 211t′ of the first coils 211′ to sense the electromagnetic pen PN (see FIG. 4). The first coils 211′ may be formed in a closed curve shape, and when a current flows through the first coils 211′, magnetic force lines may be induced between the first coils 211′ and the second coils 212′. The second coils 212′ may output a signal obtained by sensing the induced electromagnetic force emitted from the electromagnetic pen PN (see FIG. 4) to second terminals 212t′ of the second coils 212′.

A portion of one first coil 211′ among the plurality of first coils 211′ may be referred to as a third electrode 230′, and the other portion thereof may be referred to as a third trace line 230rt1′. The third electrode 230′ and the third trace line 230rt1′ may define a loop coil pattern.

The digitizer 200′ may be referred to as a sensor layer 200′.

According to the present disclosure, in an edge portion of the electronic device ED-3, the density of the magnetic field may be increased and the vertical magnetic field density may be increased. Accordingly, the amount of the magnetic field provided to the pen PN (see FIG. 4) in the edge portion may be increased. In the charging drive mode, the charging performance of the resonant circuit of the pen PN (see FIG. 4) may be relatively improved. Accordingly, the resonant circuit may have improved discharge performance. The resonant circuit may emit the pen magnetic field having the resonant frequency while discharging the charged charge. The induced current may be generated in the sensor layer 200′ by the pen magnetic field provided from the pen PN (see FIG. 4). The sensing sensitivity of the sensor layer 200′ with respect to the pen PN (see FIG. 4) may be relatively improved. Thus, the electronic device ED-3 having improved sensing performance may be provided.

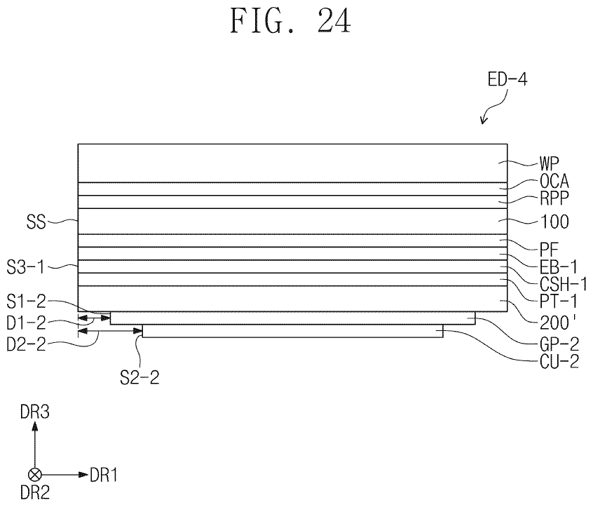

FIG. 24 is a schematic cross-sectional view of the electronic device according to some embodiments of the present disclosure. In the description of FIG. 24, the components described through FIGS. 21 and 22 are designated by the same reference numerals, and a description thereof will be omitted.

Referring to FIG. 24, an electronic device ED-4 may include the window WP, the adhesive layer OCA, the reflection preventing layer RPP, the display layer 100, the protective layer PF, the embossed layer EB-1, the cushion layer CSH-1, the reinforcing layer PT-1, the digitizer 200′, the magnetic layer GP-2, and the shielding layer CU-2.

According to the present disclosure, in an edge portion of the electronic device ED-4, the density of the magnetic field may be increased and the vertical magnetic field density may be increased. Accordingly, the amount of the magnetic field provided to the pen PN (see FIG. 4) in the edge portion may be increased. In the charging drive mode, the charging performance of the resonant circuit of the pen PN (see FIG. 4) may be relatively improved. Accordingly, the resonant circuit may have improved discharge performance. The resonant circuit may emit the pen magnetic field having the resonant frequency while discharging the charged charge. The induced current may be generated in the sensor layer 200′ by the pen magnetic field provided from the pen PN (see FIG. 4). The sensing sensitivity of the sensor layer 200′ with respect to the pen PN (see FIG. 4) may be relatively improved. Thus, the electronic device ED-4 having improved sensing performance may be provided.

According to some embodiments, in an edge portion of an electronic device, density of a magnetic field may be increased, and vertical magnetic field density may be increased. Accordingly, the amount of a magnetic field provided to a pen in the edge portion may be increased. In a charging drive mode, charging performance of a resonant circuit of the pen may be relatively improved. Accordingly, the resonant circuit may have improved discharge performance. The resonant circuit may emit a pen magnetic field having a resonant frequency while discharging a charged charge. An induced current may be generated in a sensor layer by the pen magnetic field provided by the pen. Sensing sensitivity of the sensor layer with respect to the pen may be relatively improved. Thus, the electronic device having relatively improved pen sensing performance may be provided.

Although the description has been made above with reference to aspects of some embodiments of the present disclosure, those skilled in the art may understand that the present disclosure may be variously modified and changed without departing from the spirit and the technical scope of the present disclosure described in the appended claims, and their equivalents.

Thus, the technical scope of embodiments according to the present disclosure is not limited to the detailed description of the specification but should be defined by the appended claims, and their equivalents.

What is claimed is:

1. An electronic device comprising:
a display layer;
a sensor layer in which an active area and a peripheral area are defined and which includes a first electrode in the active area and extending in a first direction and a first trace line in the peripheral area and connected to the first electrode;
a magnetic layer under the sensor layer; and
a shielding layer spaced apart from the sensor layer with the magnetic layer interposed therebetween,
wherein a first side surface of the magnetic layer and a second side surface of the shielding layer are between the first trace line and the first electrode.

2. The electronic device of claim 1, wherein, in a plan view, an area of the sensor layer is larger than an area of each of the magnetic layer and the shielding layer.

3. The electronic device of claim 1, wherein, in a plan view, the first trace line does not overlap the magnetic layer and the shielding layer.

4. The electronic device of claim 1, wherein, in a plan view, the first electrode overlaps the magnetic layer and the shielding layer.

5. The electronic device of claim 1, further comprising:
a housing in which the display layer and the sensor layer are accommodated,
wherein a first resistance of the shielding layer is smaller than a second resistance of the housing.

6. The electronic device of claim 1, wherein the sensor layer is on the display layer, and
wherein the sensor layer further includes:
a second electrode intersecting the first electrode and including a plurality of first patterns and a first bridge pattern electrically connected to the plurality of first patterns;
a third electrode overlapping at least a portion of the first electrode and including a plurality of second patterns and a second bridge pattern electrically connected to the plurality of second patterns; and
a fourth electrode intersecting the third electrode.

7. The electronic device of claim 6, wherein the first electrode and the plurality of first patterns are on a same layer, and
wherein the plurality of second patterns and the fourth electrode are on a same layer.

8. The electronic device of claim 1, further comprising:
a cushion layer and an embossed layer between the display layer and the magnetic layer.

9. The electronic device of claim 8, wherein a third side surface of each of the cushion layer and the embossed layer is aligned with the first side surface.

10. The electronic device of claim 8, wherein a third side surface of each of the cushion layer and the embossed layer is aligned with a side surface of the sensor layer.

11. The electronic device of claim 1, wherein a first distance from a side surface of the sensor layer to the first side surface is different from a second distance from the side surface of the sensor layer to the second side surface.

12. The electronic device of claim 1, wherein the sensor layer is between the display layer and the magnetic layer, and
wherein the sensor layer further includes a crossing coil insulated from and cross the first electrode and the first trace line.

13. The electronic device of claim 1, wherein the first electrode and the first trace line define a loop coil pattern.

14. An electronic device comprising:
a display layer;
a sensor layer which is on the display layer, in which an active area and a peripheral area are defined, and which includes a first electrode extending in a first direction and a first trace line connected to the first electrode;
a magnetic layer under the sensor layer;
a shielding layer spaced apart from the sensor layer with the magnetic layer interposed therebetween; and
a housing in which the display layer, the sensor layer, the magnetic layer, and the shielding layer are accommodated,
wherein, in a plan view, an area of the sensor layer is larger than an area of each of the magnetic layer and the shielding layer.

15. The electronic device of claim 14, wherein a first side surface of the magnetic layer and a second side surface of the shielding layer are between the first trace line and the first electrode.

16. The electronic device of claim 14, wherein, in the plan view, the first trace line does not overlap the magnetic layer and the shielding layer, and
wherein, in the plan view, the first electrode overlaps the magnetic layer and the shielding layer.

17. The electronic device of claim 14, wherein the sensor layer further includes:
a second electrode intersecting the first electrode and including a plurality of first patterns and a first bridge pattern electrically connected to the plurality of first patterns;
a third electrode overlapping at least a portion of the first electrode and including a plurality of second patterns and a second bridge pattern electrically connected to the plurality of second patterns; and
a fourth electrode intersecting the third electrode.

18. The electronic device of claim 14, further comprising:
a cushion layer and an embossed layer between the display layer and the magnetic layer.

19. The electronic device of claim 18, wherein a third side surface of each of the cushion layer and the embossed layer is aligned with a first side surface of the magnetic layer.

20. The electronic device of claim 18, wherein a third side surface of each of the cushion layer and the embossed layer is aligned with a side surface of the sensor layer.
